(19) United States
(12) Patent Application Publication
(10) Pub. No.: US 2020/0236712 A1
(43) Pub. Date: Jul. 23, 2020

(54) METHOD FOR TRANSMITTING RANDOM ACCESS SIGNAL IN WIRELESS COMMUNICATION SYSTEM AND APPARATUS FOR METHOD

(71) Applicant: LG ELECTRONICS INC., Seoul (KR)

(72) Inventors: Kyuhwan Kwak, Seoul (KR); Seonwook Kim, Seoul (KR); Yunjung Yi, Seoul (KR); Daesung Hwang, Seoul (KR); Kunil Yum, Seoul (KR)

(21) Appl. No.: 15/760,034

(22) PCT Filed: Sep. 26, 2016
(86) PCT No.: PCT/KR2016/010740

§ 371 Date: Mar. 14, 2018

Related U.S. Application Data
(60) Provisional application No. 62/222,795, filed on Sep. 24, 2015.

(51) Int. Cl. H04W 74/08

(52) U.S. Cl. CPC H04W 74/0833

(57) ABSTRACT

Disclosed is a method for transmitting a random access signal in a wireless communication system, the method performed by an user equipment (UE) according to the present specification comprising: transmitting a random access signal to a base station by means of a physical random access channel (PRACH) resource area of a narrow band (NB) having a system bandwidth of 180 kHz, wherein the PRACH resource area comprises a first PRACH resource area and a second PRACH resource area, each of which comprising at least one subcarrier having a particular subcarrier spacing, and any one from among the first PRACH resource area and second PRACH resource area is utilized for data transmission.

### CROSS-REFERENCE TO RELATED APPLICATIONS

This application is the National Stage filing under 35 U.S.C. 371 of International Application No. PCT/KR2016/010740, filed on Sep. 26, 2016, which claims the benefit of U.S. Provisional Application No. 62/222,795, filed on Sep. 24, 2015, the contents of which are all hereby incorporated by reference herein in their entirety.

### TECHNICAL FIELD

The present invention relates to a wireless communication system and, more particularly, to a method for transmitting a random access signal in a wireless communication system and an apparatus supporting the same.

### BACKGROUND ART

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

An object of this specification is to provide a method of configuring a transport channel for random access, which is performed by a UE when performing initial access in a wireless communication system which operates according to a frequency division multiple access (FDMA) scheme and in which the uplink is taken into consideration.

Furthermore, an object of this specification is to provide a method of transmitting RACHs transmitted by a plurality of UEs by multiplexing them in an NB-LTE system.

Furthermore, an object of this specification is to provide a method of performing the RACH transmission of a UE and the data transmission of the UE by multiplexing them in an NB-LTE system.

Furthermore, an object of this specification is to provide a method of configuring RACH resources by taking into consideration the coverage class of a UE and transmitting the RACH.

Technical objects to be achieved by this specification are not limited to the aforementioned technical objects, and other technical objects not described above may be evidently understood by a person having ordinary skill in the art to which the present invention pertains from the following description.

### Technical Solution

In this specification, in a method for transmitting a random access signal in a wireless communication system, the method performed by a UE includes the step of transmitting the random access signal to an eNB through a physical random access channel (PRACH) resource region of a narrow band (NB) having a system bandwidth of 180 kHz. The PRACH resource region includes a first PRACH resource region and a second PRACH resource region, each of the first PRACH resource region and the second PRACH resource region includes at least one subcarrier having a specific subcarrier spacing, and any one of the first PRACH resource region and the second PRACH resource region may be adaptively used for data transmission.

Furthermore, in this specification, the first PRACH resource region and the second PRACH resource region are divided in a frequency domain.

Furthermore, in this specification, the method of transmitting a random access signal further includes the steps of receiving control information related to a PRACH resource in which data is transmitted from the eNB and transmitting the data to the eNB through any one of the first PRACH resource region and the second PRACH resource region based on the received control information.

Furthermore, in this specification, the data is transmitted to the eNB through one or more subcarriers having the specific subcarrier spacing.

Furthermore, in this specification, the PRACH resource region includes one or more PRACH resources divided based on a coverage class of the UE.

Furthermore, in this specification, the one or more PRACH resources are configured as PRACH sequences having different lengths and/or different PRACH preamble formats.

Furthermore, in this specification, the method of transmitting a random access signal further includes the step of receiving information related to the one or more PRACH resources divided based on the coverage class of the UE through higher layer signaling from the eNB.

Furthermore, in this specification, in the one or more PRACH resources divided based on the coverage class of the UE, the number of subframes in which the random access signal is transmitted is differently set.

Furthermore, in this specification, a guard band is located between the first PRACH resource region and the second PRACH resource region.

Furthermore, in this specification, a UE for transmitting a random access signal in a wireless communication includes a radio frequency (RF) unit for transmitting or receiving a radio signal and a processor functionally connected to the RF unit. The processor performs control so that the random access signal is transmitted to an eNB through a physical random access channel (PRACH) resource region of a narrow band (NB) having a system bandwidth of 180 kHz. The PRACH resource region includes a first PRACH resource region and a second PRACH resource region. Each of the first PRACH resource region and the second PRACH resource region includes at least one subcarrier having a specific subcarrier spacing. Any one of the first PRACH resource region and the second PRACH resource region may be adaptively used for data transmission.

Furthermore, in this specification, in a method for transmitting a random access signal in a wireless communication system, the method performed by a UE includes the step of transmitting the random access signal to an eNB through a narrow band (NB) having a system bandwidth of 200 kHz or less. The narrow band (NB) includes 48 subcarriers having a specific subcarrier spacing, and the random access signal is transmitted using some of the 48 subcarriers.

Furthermore, in this specification, the format of the transmitted random transmission signal has a format identical with a physical uplink shared channel (PUSCH) or a form in which a demodulation reference signal (DM-RS) or a preamble is transmitted ahead of the PUSCH.

### Advantageous Effects

This specification has effects in that it can increase resource efficiency and improve a data transfer rate by transmitting data in some of a PRACH resource region.

Furthermore, this specification has an effect in that it can reduce a collision which may occur when a plurality of UEs performs initial access at the same time by dividing PRACH resources using an FDM scheme.

Furthermore, this specification has effects in that it can reduce a near-far effect which may occur if a CDM scheme is used and can reduce the delay of PRACH transmission which may occur if a TDM scheme is used by dividing PRACH resources using an FDM scheme.

Effects which may be obtained by this specification are not limited to the aforementioned effects, and other technical effects not described above may be evidently understood by a person having ordinary skill in the art to which the present invention pertains from the following description.

### DESCRIPTION OF DRAWINGS

The accompanying drawings, which are included herein as a part of a description in order to help understanding of the present invention, provide embodiments of the present invention, and describe the technical features of the present invention with the description below.

FIG. 1 illustrates a structure a radio frame in a wireless communication system to which the present invention can be applied.

FIG. 2 is a diagram illustrating a resource grid for one downlink slot in the wireless communication system to which the present invention can be applied.

FIG. 3 illustrates a structure of a downlink subframe in the wireless communication system to which the present invention can be applied.

FIG. 4 illustrates a structure of an uplink subframe in the wireless communication system to which the present invention can be applied.

FIG. 5 illustrates one example of a type in which PUCCH formats are mapped to a PUCCH region of an uplink physical resource block in the wireless communication system to which the present invention can be applied.

FIG. 6 illustrates a structure of a CQI channel in the case of a general CP in the wireless communication system to which the present invention can be applied.

FIG. 7 shows the structure of an ACK/NACK channel in the case of a normal CP in a wireless communication system to which the present invention may be applied.

FIG. 8 shows an example in which five SC-FDMA symbols are generated and transmitted during one slot in a wireless communication system to which the present invention may be applied.

FIG. 9 shows an example of component carriers and carrier aggregations in a wireless communication system to which the present invention may be applied.

FIG. 10 shows an example of the structure of a subframe according to cross-carrier scheduling in a wireless communication system to which the present invention may be applied.

FIG. 11 shows an example of the transport channel processing of an UL-SCH in a wireless communication system to which the present invention may be applied.

FIG. 12 shows an example of the signal processing process of an uplink shared channel, that is, a transport channel, in a wireless communication system to which the present invention may be applied.

FIG. 13 illustrates a reference signal pattern mapped to a downlink resource block pair in a wireless communication system to which the present invention may be applied.

FIG. 14 illustrates an uplink subframe including a sounding reference signal symbol in a wireless communication system to which the present invention may be applied.

FIG. 15 is a diagram showing an example in which a legacy PDCCH, a PDSCH and an E-PDCCH are multiplexed.

FIG. 16 is a diagram showing an example of uplink numerology in a time domain.

FIG. 17 is a diagram showing an example of time units for the uplink of NB-LTE based on 2.5 kHz subcarrier spacing.

FIG. 18 is a diagram showing an example in which an M-PRACH is multiplexed with an M-PUSCH.

FIG. 19 is a diagram showing an M-PRACH preamble length and subcarrier spacing.

FIG. 20 is a diagram showing the CP of an M-PRACH and the dimensioning of a guard time.

FIG. 21 shows an example of a random access resource configuration that satisfies time multiplexing requirements.

FIG. 22 is a diagram showing an example of the operating system of an NB LTE system to which a method proposed by this specification may be applied.

FIG. 23 is a diagram showing an example of a method of configuring PRACH resources, which is proposed by this specification.

FIG. 24 is a diagram showing another example in which a PRACH resource has been separated into two resource regions, which is proposed by this specification.

FIG. 25 is a diagram showing an example of a multiplexing method between a PUSCH and a PRACH, which is proposed by this specification.

FIG. 26 is a diagram showing an example of a PRACH transmission method according to a coverage class, which is proposed by this specification.

FIG. 27 is a diagram showing another example of a PRACH transmission method according to a coverage class, which is proposed by this specification.

FIG. 28 is a diagram showing an example in which PRACH resources have been spaced and configured in a time axis, which is proposed by this specification.

FIG. 29 is a diagram showing another example in which PRACH resources have been spaced and configured in a time axis, which is proposed by this specification.

FIG. 30 is a flowchart showing an example of a method of transmitting a random access signal in an NB-LTE system, which is proposed by this specification.

FIG. 31 shows an example of an internal block diagram of a wireless communication apparatus to which the methods proposed by this specification may be applied.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service(GPRS)/enhanced data rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

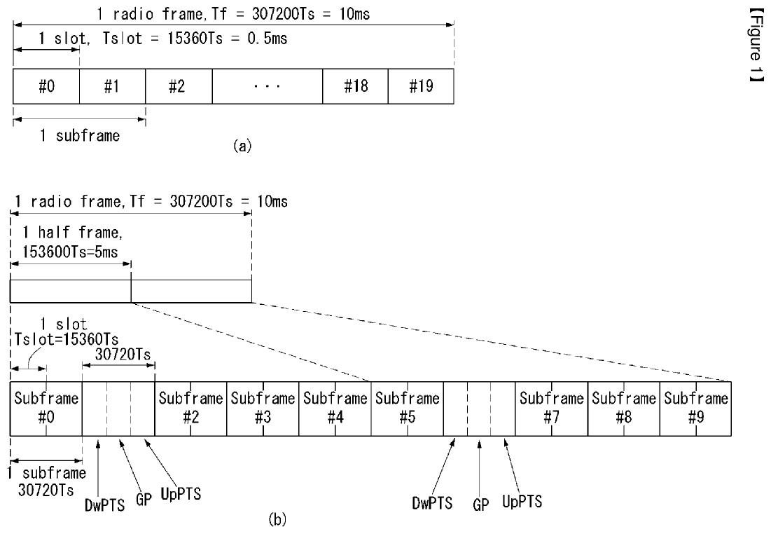

FIG. 1 illustrates a structure a radio frame in a wireless communication system to which the present invention can be applied.

In 3GPP LTE/LTE-A, radio frame structure type 1 may be applied to frequency division duplex (FDD) and radio frame structure type 2 may be applied to time division duplex (TDD) are supported.

FIG. 1(a) exemplifies radio frame structure type 1. The radio frame is constituted by 10 subframes. One subframe is constituted by 2 slots in a time domain. A time required to transmit one subframe is referred to as a transmissions time interval (TTI). For example, the length of one subframe may be 1 ms and the length of one slot may be 0.5 ms.

One slot includes a plurality of orthogonal frequency division multiplexing (OFDM) symbols in the time domain and includes multiple resource blocks (RBs) in a frequency domain. In 3GPP LTE, since OFDMA is used in downlink, the OFDM symbol is used to express one symbol period. The OFDM symbol may be one SC-FDMA symbol or symbol period. The resource block is a resource allocation wise and includes a plurality of consecutive subcarriers in one slot.

FIG. 1(b) illustrates frame structure type 2. Radio frame type 2 is constituted by 2 half frames, each half frame is constituted by 5 subframes, a downlink pilot time slot (DwPTS), a guard period (GP), and an uplink pilot time slot (UpPTS), and one subframe among them is constituted by 2 slots. The DwPTS is used for initial cell discovery, synchronization, or channel estimation in a terminal. The UpPTS is used for channel estimation in a base station and to match uplink transmission synchronization of the terminal. The guard period is a period for removing interference which occurs in uplink due to multi-path delay of a downlink signal between the uplink and the downlink.

In frame structure type 2 of a TDD system, an uplink-downlink configuration is a rule indicating whether the uplink and the downlink are allocated (alternatively, reserved) with respect to all subframes. Table 1 shows the uplink-downlink configuration.

TABLE 1

| Uplink- | | | | | | | | | | | | |
|---|---|---|---|---|---|---|---|---|---|---|---|---|
| Down- | Downlink-to- | | | | | | | | | | | |
| link | Uplink Switch- | | | | | | | | | | | |
| config- | point period- | | Subframe number | | | | | | | | | |
| uration | icity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Referring to Table 1, for each subframe of the radio frame, ‘D’ represents a subframe for downlink transmission, ‘U’ represents a subframe for uplink transmission, and ‘S’ represents a special subframe constituted by three fields such as the DwPTS, the GP, and the UpPTS. The uplink-downlink configuration may be divided into 7 configurations and the positions and/or the numbers of the downlink subframe, the special subframe, and the uplink subframe may vary for each configuration.

A time when the downlink is switched to the uplink or a time when the uplink is switched to the downlink is referred to as a switching point. Switch-point periodicity means a period in which an aspect of the uplink subframe and the downlink subframe are switched is similarly repeated and both 5 ms or 10 ms are supported. When the period of the downlink-uplink switching point is 5 ms, the special subframe S is present for each half-frame and when the period of the downlink-uplink switching point is 5 ms, the special subframe S is present only in a first half-frame.

In all configurations, subframes #0 and #5 and the DwPTS are intervals only the downlink transmission. The UpPTS and a subframe just subsequently to the subframe are continuously intervals for the uplink transmission.

The uplink-downlink configuration may be known by both the base station and the terminal as system information. The base station transmits only an index of configuration information whenever the uplink-downlink configuration information is changed to announce a change of an uplink-downlink allocation state of the radio frame to the terminal. Further, the configuration information as a kind of downlink control information may be transmitted through a physical downlink control channel (PDCCH) similarly to other scheduling information and may be commonly transmitted to all terminals in a cell through a broadcast channel as broadcasting information.

The structure of the radio frame is just one example and the number subcarriers included in the radio frame or the number of slots included in the subframe and the number of OFDM symbols included in the slot may be variously changed.

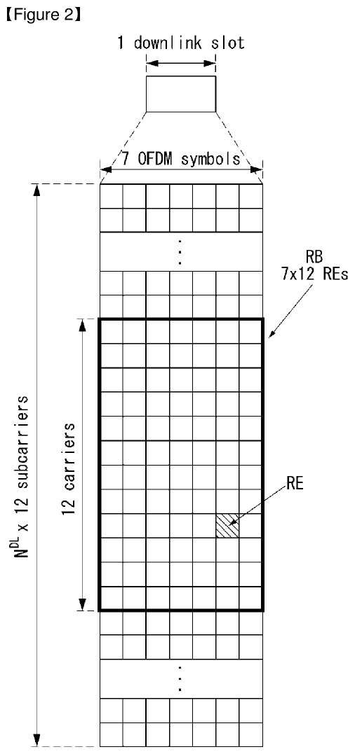

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

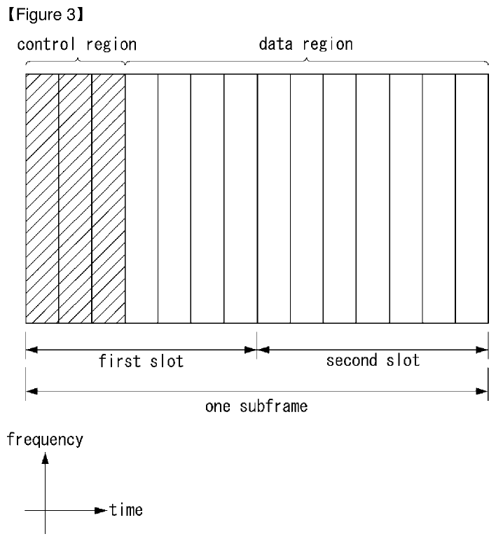

FIG. 3 illustrates a structure of a downlink subframe in the wireless communication system to which the present invention can be applied.

Referring to FIG. 3, a maximum of three former OFDM symbols in the first slot of the subframe are a control region to which control channels are allocated and residual OFDM symbols is a data region to which a physical downlink shared channel (PDSCH) is allocated. Examples of the downlink control channel used in the 3GPP LTE include a physical control format indicator channel (PCFICH), a physical downlink control channel (PDCCH), a physical hybrid-ARQ indicator channel (PHICH), and the like.

The PFCICH is transmitted in the first OFDM symbol of the subframe and transports information on the number (that is, the size of the control region) of OFDM symbols used for transmitting the control channels in the subframe.

The PHICH which is a response channel to the uplink transports an acknowledgement (ACK)/not-acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport a resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregation of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

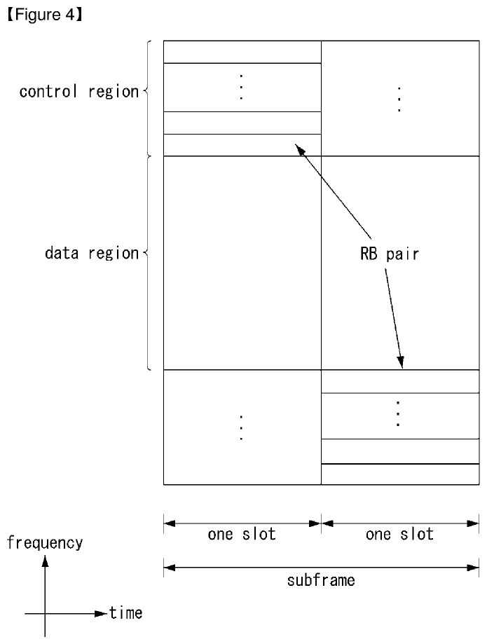

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe is allocated to the PUCCH for one terminal. RBs included in the RB pair occupy different subcarriers in two slots, respectively. The RB pair allocated to the PUCCH frequency-hops in a slot boundary.

Physical Uplink Control Channel (PUCCH)

The uplink control information (UCI) transmitted through the PUCCH may include a scheduling request (SR), HARQ ACK/NACK information, and downlink channel measurement information.

The HARQ ACK/NACK information may be generated according to a downlink data packet on the PDSCH is successfully decoded. In the existing wireless communication system, 1 bit is transmitted as ACK/NACK information with respect to downlink single codeword transmission and 2 bits are transmitted as the ACK/NACK information with respect to downlink 2-codeword transmission.

The channel measurement information which designates feedback information associated with a multiple input multiple output (MIMO) technique may include a channel quality indicator (CQI), a precoding matrix index (PMI), and a rank indicator (RI). The channel measurement information may also be collectively expressed as the CQI.

20 bits may be used per subframe for transmitting the CQI.

The PUCCH may be modulated by using binary phase shift keying (BPSK) and quadrature phase shift keying (QPSK) techniques. Control information of a plurality of terminals may be transmitted through the PUCCH and when code division multiplexing (CDM) is performed to distinguish signals of the respective terminals, a constant amplitude zero autocorrelation (CAZAC) sequence having a length of 12 is primary used. Since the CAZAC sequence has a characteristic to maintain a predetermined amplitude in the time domain and the frequency domain, the CAZAC sequence has a property suitable for increasing coverage by decreasing a peak-to-average power ratio (PAPR) or cubic metric (CM) of the terminal. Further, the ACK/NACK information for downlink data transmission performed through the PUCCH is covered by using an orthogonal sequence or an orthogonal cover (OC).

Further, the control information transmitted on the PUCCH may be distinguished by using a cyclically shifted sequence having different cyclic shift (CS) values. The cyclically shifted sequence may be generated by cyclically shifting a base sequence by a specific cyclic shift (CS) amount. The specific CS amount is indicated by the cyclic shift (CS) index. The number of usable cyclic shifts may vary depending on delay spread of the channel. Various types of sequences may be used as the base sequence the CAZAC sequence is one example of the corresponding sequence.

Further, the amount of control information which the terminal may transmit in one subframe may be determined according to the number (that is, SC-FDMA symbols other an SC-FDMA symbol used for transmitting a reference signal (RS) for coherent detection of the PUCCH) of SC-FDMA symbols which are usable for transmitting the control information.

In the 3GPP LTE system, the PUCCH is defined as a total of 7 different formats according to the transmitted control information, a modulation technique, the amount of control information, and the like and an attribute of the uplink control information (UCI) transmitted according to each PUCCH format may be summarized as shown in Table 2 given below.

TABLE 2

| PUCCH Format | Uplink Control Information(UCI) |
|---|---|
| Format 1 | Scheduling Request(SR)(unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) |
| | for extended CP only |
| Format 2a | CQI and 1-bit HARQ ACK/NACK (20 + 1 coded bits) |
| Format 2b | CQI and 2-bit HARQ ACK/NACK (20 + 2 coded bits) |

The PUCCH format 1 is used for transmitting only the SR. A waveform which is not modulated is adopted in the case of transmitting only the SR and this will be described below in detail.

The PUCCH format 1a or 1b is used for transmitting the HARQ ACK/NACK. PUCCH format 1a or 1b may be used when only the HARQ ACK/NACK is transmitted in a predetermined subframe. Alternatively, the HARQ ACK/NACK and the SR may be transmitted in the same subframe by using the PUCCH format 1a or 1b.

The PUCCH format 2 is used for transmitting the CQI and PUCCH format 2a or 2b is used for transmitting the CQI and the HARQ ACK/NACK.

In the case of an extended CP, the PUCCH format 2 may be transmitted for transmitting the CQI and the HARQ ACK/NACK.

FIG. 5 illustrates one example of a type in which PUCCH formats are mapped to a PUCCH region of an uplink physical resource block in the wireless communication system to which the present invention can be applied.

In FIG. 5, N_{RB}^{UL} represents the number of resource blocks in the uplink and 0, 1, . . . , N_{RB}^{UL}-1 mean numbers of physical resource blocks. Basically, the PUCCH is mapped to both edges of an uplink frequency block. As illustrated in FIG. 5, PUCCH format 2/2a/2b is mapped to a PUCCH region expressed as m=0, 1 and this may be expressed in such a manner that PUCCH format 2/2a/2b is mapped to resource blocks positioned at a band edge. Further, both PUCCH format 2/2a/2b and PUCCH format 1/1a/1b may be interchangeably mapped to a PUCCH region expressed as m=2. Next, PUCCH format 1/1a/1b may be mapped to a PUCCH region expressed as m=3, 4, and 5. The number (N_{RB}⁽²⁾) of PUCCH RBs which are usable by PUCCH format 2/2a/2b may be indicated to terminals in the cell by broadcasting signaling.

The PUCCH formats 2/2a/2b are described. The PUCCH formats 2/2a/2b are control channels for transmitting channel measurement feedback (CQI, PMI, and RI).

The reporting period of the channel measurement feedbacks (hereinafter, collectively expressed as CQI information) and a frequency wise (alternatively, a frequency resolution) to be measured may be controlled by the base station. In the time domain, periodic and aperiodic CQI reporting may be supported. PUCCH format 2 may be used for only the periodic reporting and the PUSCH may be used for aperiodic reporting. In the case of the aperiodic reporting, the base station may instruct the terminal to transmit a scheduling resource loaded with individual CQI reporting for the uplink data transmission.

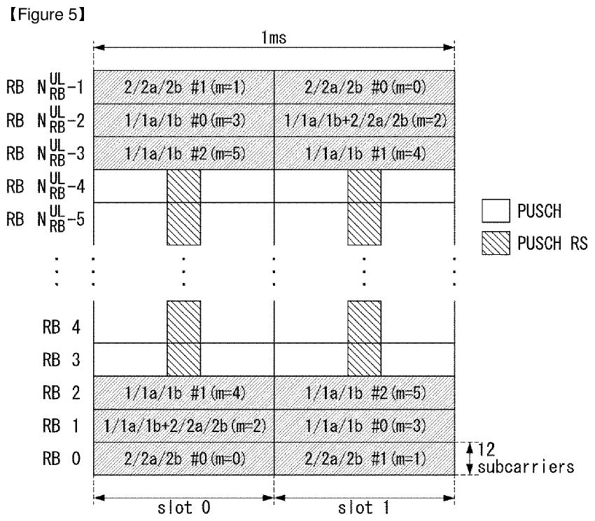

FIG. 6 illustrates a structure of a CQI channel in the case of a general CP in the wireless communication system to which the present invention can be applied.

In SC-FDMA symbols 0 to 6 of one slot, SC-FDMA symbols 1 and 5 (second and sixth symbols) may be used for transmitting a demodulation reference signal and the CQI information may be transmitted in the residual SC-FDMA symbols. Meanwhile, in the case of the extended CP, one SC-FDMA symbol (SC-FDMA symbol 3) is used for transmitting the DMRS.

In PUCCH format 2/2a/2b, modulation by the CAZAC sequence is supported and the CAZAC sequence having the length of 12 is multiplied by a QPSK-modulated symbol. The cyclic shift (CS) of the sequence is changed between the symbol and the slot. The orthogonal covering is used with respect to the DMRS.

The reference signal (DMRS) is loaded on two SC-FDMA symbols separated from each other by 3 SC-FDMA symbols among 7 SC-FDMA symbols included in one slot and the CQI information is loaded on 5 residual SC-FDMA symbols. Two RSs are used in one slot in order to support a high-speed terminal. Further, the respective terminals are distinguished by using the CS sequence. CQI information symbols are modulated and transferred to all SC-FDMA symbols and the SC-FDMA symbol is constituted by one sequence. That is, the terminal modulates and transmits the CQI to each sequence.

The number of symbols which may be transmitted to one TTI is 10 and modulation of the CQI information is determined up to QPSK. When QPSK mapping is used for the SC-FDMA symbol, since a CQI value of 2 bits may be loaded, a CQI value of 10 bits may be loaded on one slot. Therefore, a CQI value of a maximum of 20 bits may be loaded on one subframe. A frequency domain spread code is used for spreading the CQI information in the frequency domain.

The CAZAC sequence (e.g., ZC sequence) having the length of 12 may be used as the frequency domain spread code. CAZAC sequences having different CS values may be applied to the respective control channels to be distinguished from each other. IFFT is performed with respect to the CQI information in which the frequency domain is spread.

12 different terminals may be orthogonally multiplexed on the same PUCCH RB by a cyclic shift having 12 equivalent intervals. In the case of a general CP, a DMRS sequence on SC-FDMA symbol 1 and 5 (on SC-FDMA symbol 3 in the case of the extended CP) is similar to a CQI signal sequence on the frequency domain, but the modulation of the CQI information is not adopted.

The terminal may be semi-statically configured by upper-layer signaling so as to periodically report different CQI, PMI, and RI types on PUCCH resources indicated as PUCCH resource indexes (n_{PUCCH}^{(1,\tilde{p})}, n_{PUCCH}^{(2,\tilde{p})}, and n_{PUCCH}^{(3,\tilde{p})}). Herein, the PUCCH resource index (n_{PUCCH}^{(2,\tilde{p})}) is information indicating the PUCCH region used for PUCCH format 2/2a/2b and a CS value to be used.

PUCCH Channel Structure

The PUCCH formats 1a and 1b are described.

In the PUCCH formats 1a and 1b, the CAZAC sequence having the length of 12 is multiplied by a symbol modulated using a BPSK or QPSK modulation scheme. For example, a result acquired by multiplying a modulated symbol d(0) by a CAZAC sequence r(n) (n=0, 1, 2, . . . , N−1) having a length of N becomes y(0), y(1), y(2), . . . , y(N−1). y(0), . . . , y(N−1) symbols may be designated as a block of symbols. The modulated symbol is multiplied by the CAZAC sequence and thereafter, the block-wise spread using the orthogonal sequence is adopted.

A Hadamard sequence having a length of 4 is used with respect to general ACK/NACK information and a discrete Fourier transform (DFT) sequence having a length of 3 is used with respect to the ACK/NACK information and the reference signal.

The Hadamard sequence having the length of 2 is used with respect to the reference signal in the case of the extended CP.

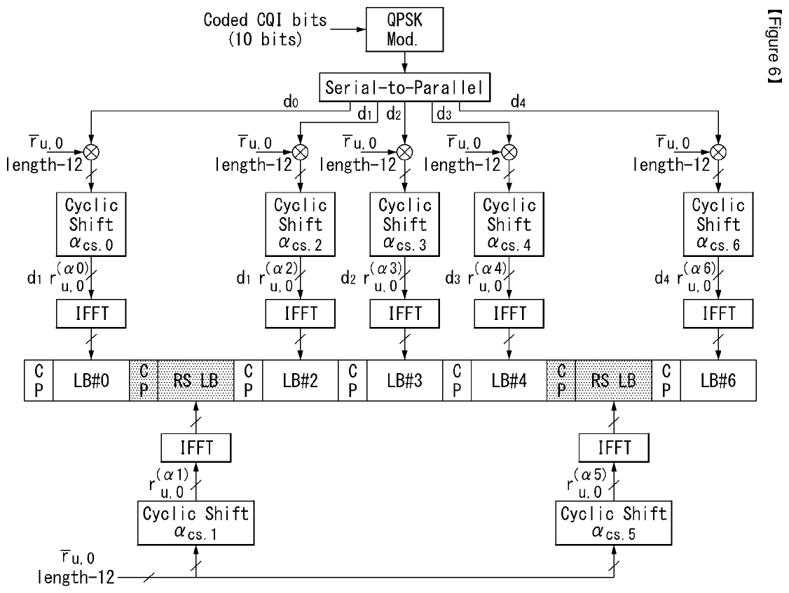

FIG. 7 shows the structure of an ACK/NACK channel in the case of a normal CP in a wireless communication system to which the present invention may be applied.

FIG. 7 illustrates a PUCCH channel structure for HARQ ACK/NACK transmission without a CQI.

A reference signal (RS) is carried on three contiguous SC-FDMA symbols that belong to seven SC-FDMA symbols included in one slot and that are located in the middle part, and an ACK/NACK signal is carried on the remaining four SC-FDMA symbols.

Meanwhile, in the case of an extended CP, an RS may be carried on two contiguous symbols in the middle part. The number of symbols and position used for an RS may be different depending on a control channel, and the number of symbols and position used for an ACK/NACK signal associated therewith may also be changed depending on the number of symbols and position used for an RS.

Acknowledgement information (the state in which it has not been scrambled) of 1 bit and 2 bits may be expressed as one HARQ ACK/NACK modulation symbol using each BPSK and QPSK modulation scheme. Acknowledgement (ACK) may be encoded into “1”, and non-acknowledgement (NACK) may be encoded into “0.”

When a control signal is transmitted within an allocated band, 2-dimension spreading is applied to increase the multiplexing capacity. That is, in order to increase the number of UEs or the number of control channels that may be multiplexed, frequency region spreading and time region spreading are applied at the same time.

In order to spread an ACK/NACK signal in the frequency domain, a frequency region sequence is used as a base sequence. A Zadoff-Chu (ZC) sequence, that is, one of CAZAC sequences, may be used as the frequency region sequence. For example, the multiplexing of different UEs or different control channels may be applied by applying different cyclic shifts (CS) to the ZC sequence, that is, a base sequence. The number of CS resources supported in an SC-FDMA symbol for PUCCH RBs for HARQ ACK/NACK transmission is configured by a cell-specific high-layer signaling parameter Δ_{shift}^{PUCCH}.

An ACK/NACK signal subjected to frequency region spreading is spread in the time domain using orthogonal spreading code. A Walsh-Hadamard sequence or a DFT sequence may be used as the orthogonal spreading code. For example, the ACK/NACK signal may be spread using an orthogonal sequence w0, w1, w2, w3 of a length 4 with respect to 4 symbols. Furthermore, an RS is spread through an orthogonal sequence of a length 3 or a length 2. This is called orthogonal covering (OC).

A plurality of UEs may be multiplexed according to a code division multiplexing (CDM) scheme using CS resources in the frequency region and OC resources in the time domain. That is, ACK/NACK information and RSs of a large number of UEs on the same PUCCH RB may be multiplexed.

The number of spreading codes supported with respect to ACK/NACK information is limited by the number of RS symbols with respect to time region spreading CDM. That is, since the number of RS transmission SC-FDMA symbols is smaller than the number of ACK/NACK information transmission SC-FDMA symbols, and thus the multiplexing capacity of an RS becomes less than the multiplexing capacity of ACK/NACK information.

For example, in the case of a normal CP, ACK/NACK information may be transmitted in four symbols. Not four orthogonal spreading codes, but three orthogonal spreading codes are used for the ACK/NACK information. The reason for this is that only three orthogonal spreading codes may be used for an RS because the number of RS transmission symbols is limited to 3.

In the case where the three symbols of one slot are used for RS transmission and four symbols thereof are used for ACK/NACK information transmission in a subframe of a normal CP, for example, if six cyclic shifts (CSs) in the frequency domain and three orthogonal covering (OC) resources in the time domain can be used, HARQ acknowledgement from a total of 18 different UEs may be multiplexed within one PUCCH RB. In the case where the two symbols of one slot are used for RS transmission and four symbols thereof are used for ACK/NACK information transmission in a subframe of an extended CP, for example, if six cyclic shifts (CSs) in the frequency domain and two orthogonal covering (OC) resources in the time domain can be used, HARQ acknowledgement from a total of 12 different UEs may be multiplexed within one PUCCH RB.

Next, the PUCCH format 1 is described. A scheduling request (SR) is transmitted in such a manner that a UE requests scheduling or does not request scheduling. An SR channel reuses an ACK/NACK channel structure in the PUCCH format 1a/1b, and configured according to an on-off keying (OOK) scheme based on the ACK/NACK channel design. A reference signal is not transmitted in the SR channel. Accordingly, a sequence of a length 7 is used in the case of a normal CP, and a sequence of a length 6 is used in the case of an extended CP. Different cyclic shifts or orthogonal coverings may be allocated to an SR and ACK/NACK. That is, for positive SR transmission, a UE transmits HARQ ACK/NACK through resources allocated for an SR. For negative SR transmission, a UE transmits HARQ ACK/NACK through resources allocated for ACK/NACK.

An enhanced-PUCCH (e-PUCCH) format is described below. The e-PUCCH may correspond to the PUCCH format 3 of an LTE-A system. A block spreading method may be applied to ACK/NACK transmission using the PUCCH format 3.

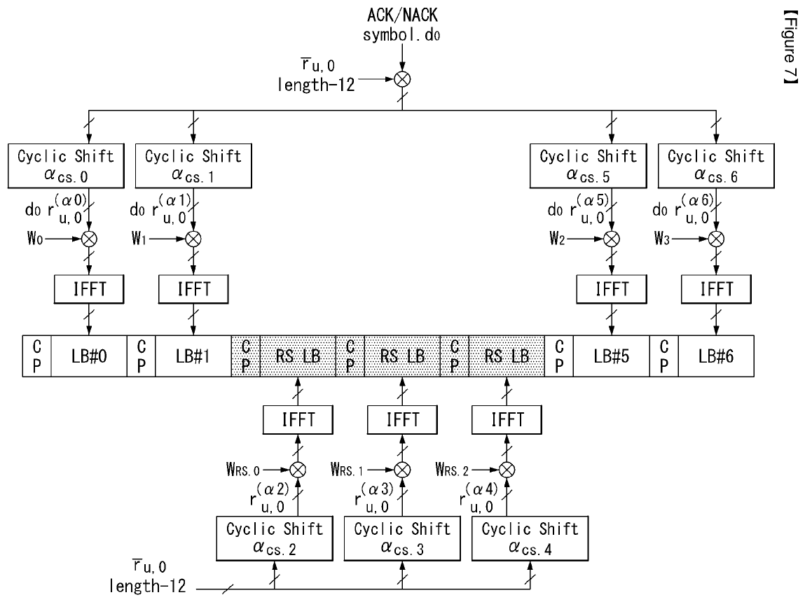

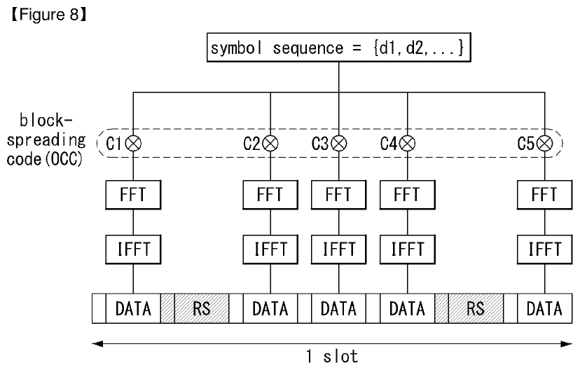

Unlike in the existing PUCCH format 1 series or 2 series, the block spreading method is a method of modulating control signal transmission using an SC-FDMA scheme. As shown in FIG. 8, a symbol sequence may be spread on the time domain using orthogonal cover code (OCC) and transmitted. The control signals of a plurality of UEs may be multiplexed on the same RB using the OCC. In the case of the PUCCH format 2, one symbol sequence is transmitted on the time domain, and the control signals of a plurality of UEs are multiplexed using the cyclic shift (CS) of a CAZAC sequence. In contrast, in the case of a block spreading-based PUCCH format (e.g., PUCCH format 3), one symbol sequence is transmitted on the frequency region, and the control signals of a plurality of UEs are multiplexed using time region spreading using the OCC.

FIG. 8 shows an example in which five SC-FDMA symbols are generated and transmitted during one slot in a wireless communication system to which the present invention may be applied.

FIG. 8 shows an example in which five SC-FDMA symbols (i.e., data parts) are generated and transmitted using OCC of a length=5 (or SF=5) in one symbol sequence during one slot. In this case, two RS symbols may be used during one slot.

In the example of FIG. 8, an RS symbol may be generated from a CAZAC sequence to which a specific cyclic shift value has been applied, and may be transmitted in a plurality of RS symbols in a form to which a specific OCC has been applied (or multiplied). Furthermore, in the example of FIG. 8, assuming that 12 modulation symbols are used for each OFDM symbol (or SC-FDMA symbol) and each modulation symbol is generated by QPSK, a maximum number of bits that may be transmitted in one slot are 12×2=24 bits. Accordingly, the number of bits that may be transmitted in 2 slots is a total of 48 bits. As described above, if the PUCCH channel structure of a block spreading method is used, control information of an extended size can be transmitted compared to the existing PUCCH format 1 series and 2 series.

General Carrier Aggregation

A communication environment considered in embodiments of the present invention includes multi-carrier supporting environments. That is, a multi-carrier system or a carrier aggregation system used in the present invention means a system that aggregates and uses one or more component carriers (CCs) having a smaller bandwidth smaller than a target band at the time of configuring a target wideband in order to support a wideband.

In the present invention, multi-carriers mean aggregation of (alternatively, carrier aggregation) of carriers and in this case, the aggregation of the carriers means both aggregation between continuous carriers and aggregation between non-contiguous carriers. Further, the number of component carriers aggregated between the downlink and the uplink may be differently set. A case in which the number of downlink component carriers (hereinafter, referred to as “DL CC”) and the number of uplink component carriers (hereinafter, referred to as “UL CC”) are the same as each other is referred to as symmetric aggregation and a case in which the number of downlink component carriers and the number of uplink component carriers are different from each other is referred to as asymmetric aggregation. The carrier aggregation may be interchangeably used with a term, such as a carrier aggregation, a bandwidth aggregation or a spectrum aggregation.

The carrier aggregation configured by combining two or more component carriers aims at supporting up to a bandwidth of 100 MHz in the LTE-A system. When one or more carriers having the bandwidth than the target band are combined, the bandwidth of the carriers to be combined may be limited to a bandwidth used in the existing system in order to maintain backward compatibility with the existing IMT system. For example, the existing 3GPP LTE system supports bandwidths of 1.4, 3, 5, 10, 15, and 20 MHz and a 3GPP LTE-advanced system (that is, LTE-A) may be configured to support a bandwidth larger than 20 MHz by using on the bandwidth for compatibility with the existing system. Further, the carrier aggregation system used in the preset invention may be configured to support the carrier aggregation by defining a new bandwidth regardless of the bandwidth used in the existing system.

The LTE-A system uses a concept of the cell in order to manage a radio resource.

The carrier aggregation environment may be called a multi-cell environment. The cell is defined as a combination of a pair of a downlink resource (DL CC) and an uplink resource (UL CC), but the uplink resource is not required. Therefore, the cell may be constituted by only the downlink resource or both the downlink resource and the uplink resource. When a specific terminal has only one configured serving cell, the cell may have one DL CC and one UL CC, but when the specific terminal has two or more configured serving cells, the cell has DL CCs as many as the cells and the number of UL CCs may be equal to or smaller than the number of DL CCs.

Alternatively, contrary to this, the DL CC and the UL CC may be configured. That is, when the specific terminal has multiple configured serving cells, a carrier aggregation environment having UL CCs more than DL CCs may also be supported. That is, the carrier aggregation may be appreciated as aggregation of two or more cells having different carrier frequencies (center frequencies). Herein, the described ‘cell’ needs to be distinguished from a cell as an area covered by the base station which is generally used.

The cell used in the LTE-A system includes a primary cell (PCell) and a secondary cell (SCell. The P cell and the S cell may be used as the serving cell. In a terminal which is in an RRC_CONNECTED state, but does not have the configured carrier aggregation or does not support the carrier aggregation, only one serving constituted by only the P cell is present. On the contrary, in a terminal which is in the RRC_CONNECTED state and has the configured carrier aggregation, one or more serving cells may be present and the P cell and one or more S cells are included in all serving cells.

The serving cell (P cell and S cell) may be configured through an RRC parameter. PhysCellId as a physical layer identifier of the cell has integer values of 0 to 503. SCellIndex as a short identifier used to identify the S cell has integer values of 1 to 7. ServCellIndex as a short identifier used to identify the serving cell (P cell or S cell) has the integer values of 0 to 7. The value of 0 is applied to the P cell and SCellIndex is previously granted for application to the S cell. That is, a cell having a smallest cell ID (alternatively, cell index) in ServCellIndex becomes the P cell.

The P cell means a cell that operates on a primary frequency (alternatively, primary CC). The terminal may be used to perform an initial connection establishment process or a connection re-establishment process and may be designated as a cell indicated during a handover process. Further, the P cell means a cell which becomes the center of control associated communication among serving cells configured in the carrier aggregation environment. That is, the terminal may be allocated with and transmit the PUCCH only in the P cell thereof and use only the P cell to acquire the system information or change a monitoring procedure. An evolved universal terrestrial radio access (E-UTRAN) may change only the P cell for the handover procedure to the terminal supporting the carrier aggregation environment by using an RRC connection reconfiguration message (RRCConnectionReconfigutaion) message of an upper layer including mobile control information (mobilityControlInfo).

The S cell means a cell that operates on a secondary frequency (alternatively, secondary CC). Only one P cell may be allocated to a specific terminal and one or more S cells may be allocated to the specific terminal. The S cell may be configured after RRC connection establishment is achieved and used for providing an additional radio resource. The PUCCH is not present in residual cells other than the P cell, that is, the S cells among the serving cells configured in the carrier aggregation environment. The E-UTRAN may provide all system information associated with a related cell which is in an RRC_CONNECTED state through a dedicated signal at the time of adding the S cells to the terminal that supports the carrier aggregation environment. A change of the system information may be controlled by releasing and adding the related S cell and in this case, the RRC connection reconfiguration (RRCConnectionReconfigutaion) message of the upper layer may be used. The E-UTRAN may perform having different parameters for each terminal rather than broadcasting in the related S cell.

After an initial security activation process starts, the E-UTRAN adds the S cells to the P cell initially configured during the connection establishment process to configure a network including one or more S cells. In the carrier aggregation environment, the P cell and the S cell may operate as the respective component carriers. In an embodiment described below, the primary component carrier (PCC) may be used as the same meaning as the P cell and the secondary component carrier (SCC) may be used as the same meaning as the S cell.

FIG. 9 illustrates examples of a component carrier and carrier aggregation in the wireless communication system to which the present invention can be applied.

FIG. 9a illustrates a single carrier structure used in an LTE system. The component carrier includes the DL CC and the UL CC. One component carrier may have a frequency range of 20 MHz.

FIG. 9b illustrates a carrier aggregation structure used in the LTE system. In the case of FIG. 9b, a case is illustrated, in which three component carriers having a frequency magnitude of 20 MHz are combined.

Each of three DL CCs and three UL CCs is provided, but the number of DL CCs and the number of UL CCs are not limited. In the case of carrier aggregation, the terminal may simultaneously monitor three CCs, and receive downlink signal/data and transmit uplink signal/data.

When N DL CCs are managed in a specific cell, the network may allocate M (M≤N) DL CCs to the terminal. In this case, the terminal may monitor only M limited DL CCs and receive the DL signal. Further, the network gives L (L≤M≤N) DL CCs to allocate a primary DL CC to the terminal and in this case, UE needs to particularly monitor L DL CCs. Such a scheme may be similarly applied even to uplink transmission.

A linkage between a carrier frequency (alternatively, DL CC) of the downlink resource and a carrier frequency (alternatively, UL CC) of the uplink resource may be indicated by an upper-layer message such as the RRC message or the system information. For example, a combination of the DL resource and the UL resource may be configured by a linkage defined by system information block type 2 (SIB2). In detail, the linkage may mean a mapping relationship between the DL CC in which the PDCCH transporting a UL grant and a UL CC using the UL grant and mean a mapping relationship between the DL CC (alternatively, UL CC) in which data for the HARQ is transmitted and the UL CC (alternatively, DL CC) in which the HARQ ACK/NACK signal is transmitted.

Cross Carrier Scheduling

In the carrier aggregation system, in terms of scheduling for the carrier or the serving cell, two types of a self-scheduling method and a cross carrier scheduling method are provided. The cross carrier scheduling may be called cross component carrier scheduling or cross cell scheduling.

The cross carrier scheduling means transmitting the PDCCH (DL grant) and the PDSCH to different respective DL CCs or transmitting the PUSCH transmitted according to the PDCCH (UL grant) transmitted in the DL CC through other UL CC other than a UL CC linked with the DL CC receiving the UL grant.

Whether to perform the cross carrier scheduling may be UE-specifically activated or deactivated and semi-statically known for each terminal through the upper-layer signaling (for example, RRC signaling).

When the cross carrier scheduling is activated, a carrier indicator field (CIF) indicating through which DL/UL CC the PDSCH/PUSCH the PDSCH/PUSCH indicated by the corresponding PDCCH is transmitted is required. For example, the PDCCH may allocate the PDSCH resource or the PUSCH resource to one of multiple component carriers by using the CIF. That is, the CIF is set when the PDSCH or PUSCH resource is allocated to one of DL/UL CCs in which the PDCCH on the DL CC is multiply aggregated. In this case, a DCI format of LTE-A Release-8 may extend according to the CIF. In this case, the set CIF may be fixed to a 3-bit field and the position of the set CIF may be fixed regardless of the size of the DCI format. Further, a PDCCH structure (the same coding and the same CCE based resource mapping) of the LTE-A Release-8 may be reused.

In contrast, when the PDCCH on the DL CC allocates the PDSCH resource on the same DL CC or allocates the PUSCH resource on a UL CC which is singly linked, the CIF is not set. In this case, the same PDCCH structure (the same coding and the same CCE based resource mapping) and DCI format as the LTE-A Release-8 may be used.

When the cross carrier scheduling is possible, the terminal needs to monitor PDCCHs for a plurality of DCIs in a control region of a monitoring CC according to a transmission mode and/or a bandwidth for each CC. Therefore, a configuration and PDCCH monitoring of a search space which may support monitoring the PDCCHs for the plurality of DCIs are required.

In the carrier aggregation system, a terminal DL CC aggregate represents an aggregate of DL CCs in which the terminal is scheduled to receive the PDSCH and a terminal UL CC aggregate represents an aggregate of UL CCs in which the terminal is scheduled to transmit the PUSCH. Further, a PDCCH monitoring set represents a set of one or more DL CCs that perform the PDCCH monitoring. The PDCCH monitoring set may be the same as the terminal DL CC set or a subset of the terminal DL CC set. The PDCCH monitoring set may include at least any one of DL CCs in the terminal DL CC set. Alternatively, the PDCCH monitoring set may be defined separately regardless of the terminal DL CC set. The DL CCs included in the PDCCH monitoring set may be configured in such a manner that self-scheduling for the linked UL CC is continuously available. The terminal DL CC set, the terminal UL CC set, and the PDCCH monitoring set may be configured UE-specifically, UE group-specifically, or cell-specifically.

When the cross carrier scheduling is deactivated, the deactivation of the cross carrier scheduling means that the PDCCH monitoring set continuously means the terminal DL CC set and in this case, an indication such as separate signaling for the PDCCH monitoring set is not required. However, when the cross carrier scheduling is activated, the PDCCH monitoring set is preferably defined in the terminal DL CC set. That is, the base station transmits the PDCCH through only the PDCCH monitoring set in order to schedule the PDSCH or PUSCH for the terminal.

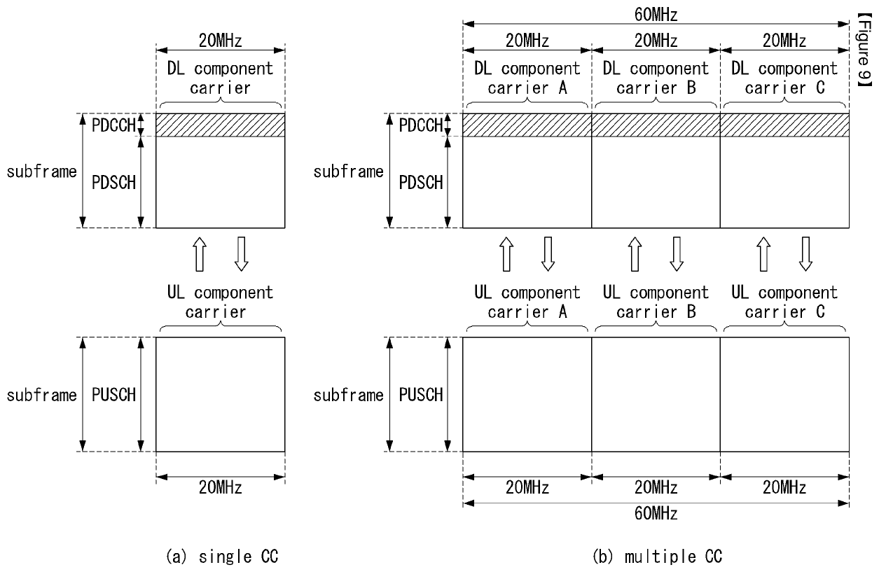

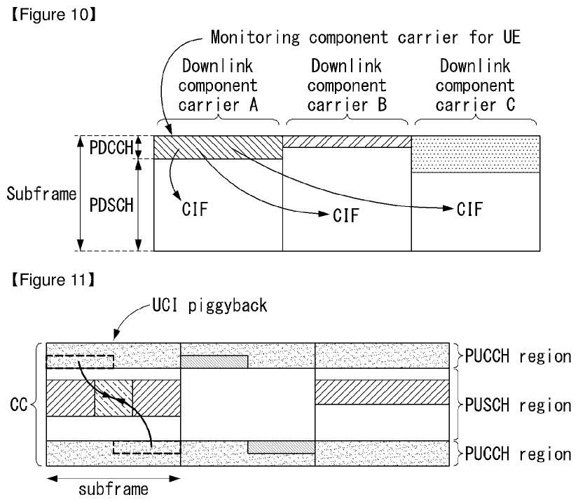

FIG. 10 illustrates one example of a subframe structure depending on cross carrier scheduling in the wireless communication system to which the present invention can be applied.

Referring to FIG. 10, a case is illustrated, in which three DL CCs are associated with a DL subframe for an LTE-A terminal and DL CC ‘A’ is configured as a PDCCH monitoring DL CC. When the CIF is not used, each DL CC may transmit the PDCCH scheduling the PDSCH thereof without the CIF. On the contrary, when the CIF is used through the upper-layer signaling, only one DL CC ‘A’ may transmit the PDCCH scheduling the PDSCH thereof or the PDSCH of another CC by using the CIF. In this case, DL CC ‘B’ and ‘C’ in which the PDCCH monitoring DL CC is not configured does not transmit the PDCCH.

Common ACK/NACK Multiplexing Method

In a situation in which a UE has to transmit a plurality of ACK/NACKs corresponding to a plurality of data units received from an eNB at the same time, in order to maintain the single-frequency characteristic of an ACK/NACK signal and to reduce ACK/NACK transmission power, an ACK/NACK multiplexing method based on the selection of PUCCH resources may be taken into consideration.

The content of ACK/NACK responses to the plurality of data units along with ACK/NACK multiplexing is identified by a combination of PUCCH resources used for actual ACK/NACK transmission and the resources of QPSK modulation symbols.

For example, if one PUCCH resources transmit 4 bits and a maximum of 4 data units may be transmitted, ACK/NACK results may be identified by an eNB as in Table 3.

TABLE 3

| HARQ-ACK(0), HARQ-ACK(1), | | |
|---|---|---|
| HARQ-ACK(2),HARQ-ACK(3) | n_{PUCCH}⁽¹⁾ | b(0), b(1) |
| ACK, ACK, ACK, ACK | n_{PUCCH,1}⁽¹⁾ | 1, 1 |
| ACK, ACK, ACK, NACK/DTX | n_{PUCCH,1}⁽¹⁾ | 1, 0 |
| NACK/DTX, NACK/DTX, NACK, DTX | n_{PUCCH,2}⁽¹⁾ | 1, 1 |
| ACK, ACK, NACK/DTX, ACK | n_{PUCCH,1}⁽¹⁾ | 1, 0 |
| NACK, DTX, DTX, DTX | n_{PUCCH,0}⁽¹⁾ | 1, 0 |
| ACK, ACK, NACK/DTX, NACK/DTX | n_{PUCCH,1}⁽¹⁾ | 1, 0 |
| ACK, NACK/DTX, ACK, ACK | n_{PUCCH,3}⁽¹⁾ | 0, 1 |
| NACK/DTX, NACK/DTX, NACK/ | n_{PUCCH,3}⁽¹⁾ | 1, 1 |
| DTX, NACK | | |
| ACK, NACK/DTX, ACK, NACK/DTX | n_{PUCCH,2}⁽¹⁾ | 0, 1 |
| ACK, NACK/DTX, NACK/DTX, ACK | n_{PUCCH,0}⁽¹⁾ | 0, 1 |
| ACK, NACK/DTX, NACK/DTX, | n_{PUCCH,0}⁽¹⁾ | 1, 1 |
| NACK/DTX | | |
| NACK/DTX, ACK, ACK, ACK | n_{PUCCH,3}⁽¹⁾ | 0, 1 |
| NACK/DTX, NACK, DTX, DTX | n_{PUCCH,1}⁽¹⁾ | 0, 0 |
| NACK/DTX, ACK, ACK, NACK/DTX | n_{PUCCH,2}⁽¹⁾ | 1, 0 |
| NACK/DTX, ACK, NACK/DTX, ACK | n_{PUCCH,3}⁽¹⁾ | 1, 0 |
| NACK/DTX, ACK, NACK/DTX, | n_{PUCCH,1}⁽¹⁾ | 0, 1 |
| NACK/DTX | | |
| NACK/DTX, NACK/DTX, ACK, ACK | n_{PUCCH,3}⁽¹⁾ | 0, 1 |
| NACK/DTX, NACK/DTX, ACK, | n_{PUCCH,2}⁽¹⁾ | 0, 0 |
| NACK/DTX | | |
| NACK/DTX, NACK/DTX, | n_{PUCCH,3}⁽¹⁾ | 0, 0 |
| NACK/DTX, ACK | | |
| DTX, DTX, DTX, DTX | N/A | N/A |

In Table 3, HARQ-ACK(i) indicates ACK/NACK results for an i-th data unit. In Table 3, discontinuous transmission (DTX) means that there is no data unit to be transmitted for corresponding HARQ-ACK(i) or that a UE has not detected a data unit corresponding to HARQ-ACK(i).

According to Table 3, a maximum of four PUCCH resources n_{PUCCH,0}⁽¹⁾, n_{PUCCH,1}⁽¹⁾, n_{PUCCH,2}⁽¹⁾, and n_{PUCCH,3}⁽¹⁾ are present, and b(0), b(1) is 2 bits transmitted using a selected PUCCH.

For example, when a UE successfully receives all of 4 data units, the UE transmits the 2 bits (1,1) using n_{PUCCH,1}⁽¹⁾.

If the UE fails in decoding the first and the third data units and are successful in decoding the second and the fourth data units, the UE transmits the bits (1,0) using n_{PUCCH,3}⁽¹⁾.

In ACK/NACK channel selection, if at least one ACK is present, NACK and DTX are coupled. The reason for this is that all of ACK/NACK states cannot be expressed using a combination of reserved PUCCH resources and an QPSK symbol. If ACK is not present, however, the DTX is decoupled from the NACK.

In this case, a PUCCH resource linked to a data unit corresponding to one clear NACK may be reserved to transmit a plurality of signals of ACK/NACKs.

PDCCH Validation for Semi-Persistent Scheduling

Semi-persistent scheduling (SPS) is a scheduling method for allocating resources to a specific UE so that the resources are persistently maintained for a specific time interval.

If a specific amount of data is transmitted during a specific time as in the voice over Internet protocol (VoIP), the consumption of control information can be reduce using the SPS scheme because it is not necessary to transmit the control information every data transmission interval for resource allocation. In the so-called semi-persistent scheduling (SPS) method, a time resource region to which resources may be allocated is first allocated to a UE.

In this case, in the semi-persistent scheduling method, a time resource region allocated to a specific UE may be configured to have periodicity. Thereafter, the allocation of time-frequency resources is completed by allocating a frequency resource region, if necessary. To allocate the frequency resource region as described is called so-called activation. If the semi-persistent scheduling method is used, signaling overhead can be reduced because resource allocation is maintained for a specific time by one signaling and thus it is not necessary to perform resource allocation periodically.

Thereafter, if resource allocation to the UE is not necessary, signaling for releasing the frequency resource allocation may be transmitted from an eNB to the UE. To release the allocation of the frequency resource region as described may be called deactivation.

In current LTE, for SPS for the uplink and/or the downlink, first, a UE is notified that the UE has to perform SPS transmission/reception in which subframes through radio resource control (RRC) signaling. That is, the time resource of time-frequency resources allocated for SPS is first designated through RRC signaling. In order to notify the UE of a subframe to be used, for example, the UE may be notified of the cycle and offset of a subframe, for example. However, since only the time resource region is allocated to the UE through RRC signaling, the UE does not directly perform transmission and reception according to SPS although it receives the RRC signaling, and completes the allocation of time-frequency resources by allocating a frequency resource region. To allocate the frequency resource region as described above may be called activation, and to release the allocation of the frequency resource region may be called deactivation.

Accordingly, after receiving a PDCCH indicative of activation, the UE allocates a frequency resource according to RB allocation information included in the received PDCCH and starts to perform transmission and reception based on the subframe cycle and offset allocated through the RRC signaling by applying a modulation and code rate according to modulation and coding scheme (MCS) information.

Next, when the UE receives a PDCCH indicative of deactivation from the eNB, it stops transmission and reception. When a PDCCH indicative of activation or reactivation is received after the transmission and reception are stopped, the UE resumes transmission and reception based on a subframe cycle and offset allocated through RRC signaling using RB allocation and an MCS designated in the PDCCH. That is, the allocation of the time resource is performed through RRC signaling, but the transmission and reception of an actual signal may be performed after a PDCCH indicative of the activation and reactivation of SPS is received. The stop of the signal transmission and reception is performed after a PDCCH indicative of the deactivation of the SPS is received.

If all the following conditions are satisfied, the UE may validate a PDCCH including SPS indication. First, CRC parity bits added for PDCCH payload need to be scrambled in to an SPS C-RNTI. Second, a data indicator (NDI) field needs to be set to 0. In this case, in the case of the DCI formats 2, 2A, 2B and 2C, a new data indicator field indicates one of activated transport blocks.

Furthermore, when each field used for the DCI format is set according to Table 4 and Table 5, the validation is completed. When such a validation is completed, the UE recognizes that received DCI information is valid SPS activation or deactivation (or release). In contrast, if the validation is not completed, the UE recognizes that non-matching CRC has been included in the received DCI format.

Table 4 shows fields for PDCCH validation indicative of SPS activation.

TABLE 4

| | DCI | DCI | DCI |
|---|---|---|---|
| | format 0 | format 1/1A | format 2/2A/2B |
| TPC command for | set to ″00″ | N/A | N/A |
| scheduled the PUSCH | | | |
| Cyclic shift DM RS | set to ″000″ | N/A | N/A |
| Modulation and coding | MSB is set | N/A | N/A |
| scheme and redundancy | to ″0″ | | |
| version | | | |
| HARQ process number | N/A | FDD: set to | FDD: set to ″000″ |
| | | ″000″ | TDD: set to ″0000″ |
| | | TDD: set to | |
| | | ″0000″ | |
| Modulation and coding | N/A | MSB is set to | For the enabled |
| scheme | | ″0″ | transport block: |
| | | | MSB is set to ″0″ |
| Redundancy version | N/A | set to ″00″ | For the enabled |
| | | | transport block: |
| | | | set to ″00″ |

Table 5 shows fields for PDCCH validation indicative of SPS deactivation (or release).

TABLE 5

| | DCI format 0 | DCI format 1A |
|---|---|---|
| TPC command for scheduled PUSCH | set to ′00′ | N/A |
| Cyclic shift DM RS | set to ′000′ | N/A |
| Modulation and coding scheme and | set to ′11111′ | N/A |
| redundancy version | | |
| Resource block assignment and | Set to all “1”s | N/A |
| hopping resource allocation | | |
| HARQ process number | N/A | FDD: set to ′000′ |
| | | TDD: set to ′0000′ |
| Modulation and coding scheme | N/A | set to ′11111′ |
| Redundancy version | N/A | set to ′00′ |
| Resource block assignment | N/A | Set to all “1”s |

If the DCI format indicates SPS downlink scheduling activation, a TPC command value for a PUCCH field may be used an index indicative of 4 PUCCH resource values configured by a higher layer.

PUCCH Piggybacking in Rel-8 LTE

FIG. 11 shows an example of the transport channel processing of an UL-SCH in a wireless communication system to which the present invention may be applied.

In the 3GPP LTE system (=E-UTRA, Rel. 8), in the case of UL, for the efficient utilization of the power AMP of a UE, single carrier transmission having a good peak-to-average power ratio (PAPR) characteristic or cubic metric (CM) characteristic that affects performance of the power AMP has been made to be maintained. That is, in the case of PUSCH transmission of the existing LTE system, data to be transmitted maintains a single carrier characteristic through DFT-precoding. In the case of PUCCH transmission, information is carried on a sequence having the single carrier characteristic and transmitted in order to maintain the single carrier characteristic. However, in DFT-precoding, if one datum is non-contiguously allocated in the frequency axis or a PUSCH and a PUCCH are transmitted at the same time, such a single carrier characteristic is broken. Accordingly, as in FIG. 11, if PUSCH transmission is present in the same subframe as PUCCH transmission, in order to maintain the single carrier characteristic, uplink control information (UCI) information to be transmitted in the PUCCH has been piggybacked through the PUSCH.

As described above, the existing LTE UE uses a method of multiplexing uplink control information (UCI) (CQI/PMI, HARQ-ACK, and RI) with a PUSCH region in a subframe in which a PUSCH is transmitted because a PUCCH and a PUSCH cannot be transmitted at the same time.

For example, if a channel quality indicator (CQI) and/or a precoding matrix indicator (PMI) have to be transmitted in a subframe allocated to transmit a PUSCH, UL-SCH data and the CQI/PMI may be multiplexed prior to DFT-spreading and transmitted along with control information and data. In this case, rate-matching is performed on the UL-SCH data by taking into consideration CQI/PMI resources. Furthermore, a method of puncturing the UL-SCH data and multiplexing the control information, such as the HARQ ACK, and RI, with the PUSCH region is used.

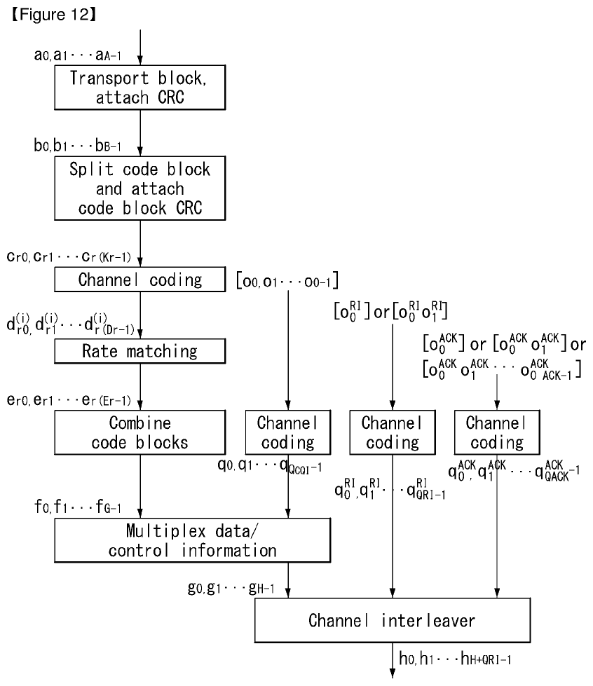

FIG. 12 shows an example of the signal processing process of an uplink shared channel, that is, a transport channel, in a wireless communication system to which the present invention may be applied.

Hereinafter, the signal processing process of an uplink shared channel (hereinafter called an “UL-SCH”) may be applied to one or more transport channels or control information types.

Referring to FIG. 12, an UL-SCH transfers data to a coding unit in the form of a transport block (TB) every transmission time interval (TTI).

CRC parity bits P₀, P₁, P₂, P₃, . . . , P_{L-1} are attached to the bits a₀, a₁, a₂, a₃, . . . , a_{A-1} of the transport block received from a higher layer (S120). In this case, A is the size of the transport block, and L is the number of parity bits. Input bits to which the CRC has been attached are b₀, b₁, b₂, b₃, . . . , b_{B-1}. In this case, B indicates the number of bits of the transport block including the CRC.

b₀, b₁, b₂, b₃, . . . , b_{B-1} is segmented into several code blocks (CB) depending on the TB size and CRC is attached to the segmented several CBs (S121). After the code block segmentation and the CRC attachment, bits are Cᵣ₀, Cᵣ₁, Cᵣ₂, Cᵣ₃, . . . , C_{r(K}_{ᵣ}₋₁₎. In this case, r is a code block number (r=0, . . . , C−1), and Kr is the number of bits according to the code block r. Furthermore, C indicates a total number of code blocks.

Next, channel coding is performed (S122). Output bits after the channel coding are dᵣ₀⁽ⁱ⁾, dᵣ₁⁽ⁱ⁾, dᵣ₂⁽ⁱ⁾, dᵣ₃⁽ⁱ⁾, . . . , d_{r(D}_{ᵣ}_{^{−1)}}⁽ⁱ⁾ In this case, i is a coded stream index and may have a 0, 1 or 2 value. Dr indicates the number of bits of an i-th coded stream for the code block r. r is a code block number (r=0, . . . , C−1), and C indicates a total number of code blocks. Each code block may be coded by each turbo coding.

Next, rate matching is performed (S123). Bits after experiencing the rate matching are eᵣ₀, eᵣ₁, eᵣ₂, eᵣ₃, . . . , e_{r(E}_{ᵣ}₋₁₎. In this case, r indicates a code block number (r=0, . . . , C−1), and C indicates a total number of code blocks. Er indicates the number of rate-matched bits of the r-th code block.

Next, the concatenation between the code blocks is performed (S124). Bits after the concatenation of the code blocks is performed are f₀, f₁, f₂, f₃, . . . , f_{G-1}. In this case, G indicates a total number of coded bits for transmission. When control information is multiplexed with UL-SCH transmission, the number of bits used for control information transmission is not included.

Meanwhile, when control information is transmitted in a PUSCH, channel coding is performed on each of a CQI/PMI, an RI, and ACK/NACK, that is, control information (S126, S127, S128). For the transmission of each of the pieces of control information, each of the pieces of control information has a different coding rate because a different coded symbol is allocated to each of the pieces of control information.

In time division duplex (TDD), two modes of ACK/NACK bundling and ACK/NACK multiplexing are supported for an ACK/NACK feedback mode by a higher layer configuration. For the ACK/NACK bundling, an ACK/NACK information bit includes 1 bit or 2 bits. For the ACK/NACK multiplexing, an ACK/NACK information bit has 1 bit to 4 bits.

After the code blocks are concatenated at step S134, the multiplexing of the coded bits f₀, f₁, f₂, f₃, . . . , f_{G-1} of the UL-SCH data and the coded bits q₀, q₁, q₂, q₃, . . . , q_{N}_{_{L}}_{·Q}_{_{CQI}}₋₁ of the CQI/PMI is performed (S125). The multiplexed results of the data and the CQI/PMI are g₀, g₁, g₂, g₃, . . . , g_{H′-1}. In this case, gᵢ, (i=0, . . . , H′-1) indicates a column vector having a (Qₘ·N_{L}) length. H=(G+N_{L}·Q_{CQI}) and H′=H/(N_{L}·Qₘ). N_{L} indicates the number of layers to which an UL-SCH transmission block has been mapped, and H indicates a total number of coded bits allocated to N_{L} transport layers to which a transport block has been mapped for the UL-SCH data and the CQI/PMI information.

Next, the multiplexed data, the CQI/PMI, and the channel coded RI and ACK/NACK are subjected to channel interleaving to generate an output signal (S129).

Reference Signal (RS)

In a wireless communication system, a signal may be distorted during transmission because data is transmitted through a radio channel. In order for a reception stage to accurately receive the distorted signal, the distortion of the received signal must be corrected using channel information. In order to detect the channel information, a signal transmission method known to both the transmission side and the reception side and a method of detecting the channel information using the degree that the signal has been distorted when the signal is transmitted through the channel are chiefly used. The aforementioned signal is called a pilot signal or a reference signal (RS).

When data is transmitted and received using multiple input/output antennas, a channel state between a transmission antenna and a reception antenna must be detected in order to accurately receive the signal. Accordingly, each transmission antenna must have each reference signal.

A downlink reference signal includes a common reference signal (CRS) shared by all of UEs within one cell and a dedicated reference signal (DRS) for only a specific UE. Information for demodulation and channel measurement may be provided using reference signals.

A reception side (i.e., UE) measures a channel state from a CRS and feeds an indicator related to channel quality, such as a channel quality indicator (CQI), a precoding matrix index (PMI) and/or a rank indicator (RI), back to a transmission side (i.e., eNB). The CRS is also called a cell-specific reference signal (cell-specific RS). In contrast, a reference signal related to the feedback of channel state information (CSI) may be defined as a CSI-RS.

A DRS may be transmitted through resource elements if data demodulation on a PDSCH is necessary. The UE may receive whether a DRS is present or not through a higher layer, and the DRS is valid only when it is mapped to a corresponding PDSCH. The DRS may be called a UE-specific reference signal (UE-specific RS) or a demodulation RS (DMRS).

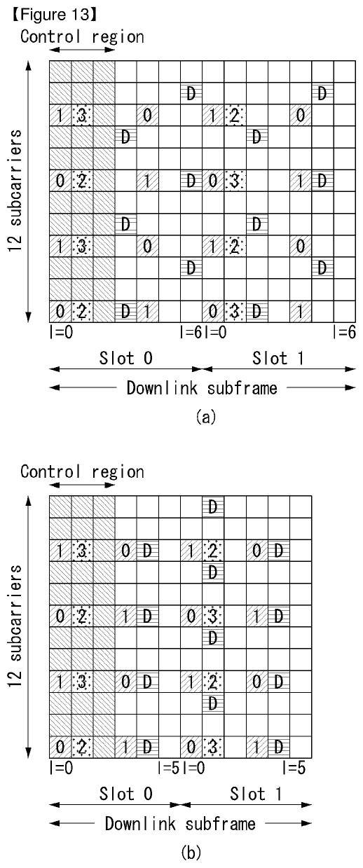

FIG. 13 illustrates a reference signal pattern mapped to a downlink resource block pair in a wireless communication system to which the present invention may be applied.

Referring to FIG. 13, as a unit in which a reference signal is mapped, a downlink resource block pair may be indicated as one subframe in the time domain× 12 subcarriers in the frequency domain. That is, one resource block pair on the time axis (x axis) has a length of 14 OFDM symbols in the case of a normal cyclic prefix (normal CP) (FIG. 13a), and has a length of 12 OFDM symbol in the case of an extended cyclic prefix (extended CP) (FIG. 13b). In the resource block lattice, resource elements (REs) written in “0”, “1”, “2” and “3” mean the positions of the CRSs of respective antenna port indices “0”, “1”, “2” and “3”, and a resource element written in “D” means the position of a DRS.

A CRS is described more specifically below. The CRS is used to estimate the channel of a physical antenna and is a reference signal that may be received by all of UEs located within a cell in common and is distributed to a full frequency band. Furthermore, the CRS may be used for channel quality information (CSI) and data demodulation.

A CRS is defined in various formats depending on an antenna array in a transmission side (eNB). In the 3GPP LTE system (e.g., Release-8), various antenna arrays are supported, and a downlink signal transmission side has three types of antenna arrays, such as 3-single transmission antennas, 2 transmission antennas and 4 transmission antennas. If the eNB uses a single transmission antenna, a reference signal for a single antenna port is arrayed. If the eNB uses the 2 transmission antennas, reference signals for 2 transmission antenna ports are arrayed using a time division multiplexing (TDM) scheme and/or a frequency segmented multiplexing (FDM) scheme. That is, in order to distinguish between the reference signals for the 2 antenna ports, different time resources and/or different frequency resources are allocated.

Moreover, if the eNB uses the 4 transmission antennas, reference signals for 4 transmission antenna ports are arrayed using the TDM and/or FDM scheme. Channel information measured by the reception side (UE) of a downlink signal may be used to demodulate data transmitted using a transmission scheme, such as single transmission antenna transmission, transmit diversity, closed-loop spatial multiplexing, open-loop spatial multiplexing or multi-user-multiple input/output antennas (multi-user MIMO).

If multiple input/output antennas are supported, when a reference signal is transmitted by a specific antenna port, the reference signal is transmitted at the position of specific resource elements depending on the pattern of the reference signal, and is not transmitted at the position of specific resource elements for other antenna ports. That is, a reference signal between different antennas does not overlap.

A rule that a CRS is mapped to a resource block is defined as follows.

$$\begin{matrix} k = 6 m + ( v + {v}_{shift} ) mod 6 & [ Equation 1 ] \\ l = \{ \begin{matrix}0 , {N}_{symb}^{D L} - 3 & if p ∈ \{ 0 , 1 \} \\ 1 & if p ∈ \{ 2 , 3 \}\end{matrix} & \\ m = 0 , 1 , … , 2 \cdot {N}_{R B}^{D L} - 1 & \\ {m}^{′} = m + {N}_{R B}^{max , DL} - {N}_{R B}^{D L} & \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s } mod 2 ) & if p = 3\end{matrix} & \\ {v}_{shift} = {N}_{ID}^{cell} mod 6 & \end{matrix}$$

In Equation 1, k and l indicates each subcarrier index and symbol index, and p indicates an antenna port. N_{symb}^{DL} indicates the number of OFDM symbols in one downlink slot, and N_{RB}^{DL} indicates the number of radio resources allocated to the downlink. Ns indicates a slot index, and N_{ID}^{cell} indicates a cell ID. mod indicates modulo operation. The position of a reference signal is different depending on a v_{shift} value in the frequency domain. Since v_{shift} depends on a cell ID, the position of the reference signal has various frequency shift values depending on a cell.

More specifically, in order to improve channel estimation performance through a CRS, the position of the CRS may be shifted in the frequency domain depending on a cell. For example, if a reference signal is located at intervals of 3 subcarriers, reference signals in one cell are allocated to a 3k-th subcarrier, and a reference signal in another cell is allocated to a (3k+1)-th subcarrier. From a viewpoint of one antenna port, reference signals are arrayed at intervals of 6 resource elements in the frequency domain, and are decoupled from a reference signal allocated to another antenna port at intervals of 3 resource elements.

In the time domain, a reference signal starts from the symbol index 0 of each slot and is arranged at a constant interval. The time interval is differently defined depending on a cyclic shift length. In the case of a normal cyclic prefix, a reference signal is located at the symbol indices 0 and 4 of a slot. In the case of an extended cyclic prefix, a reference signal is located at the symbol indices 0 and 3 of a slot. A reference signal for an antenna port that belongs to two antenna ports and that has a maximum value is defined within one OFDM symbol. Accordingly, in the case of 4-transmission antenna transmission, reference signals for reference signal antenna ports 0 and 1 are located at the symbol indices 0 and 4 (symbol indices 0 and 3 in the case of an extended cyclic prefix) of a slot. Reference signals for antenna ports 2 and 3 are located at the symbol index 1 of a slot. The position of a reference signal for the antenna ports 2 and 3 in the frequency region is exchanged in the second slot.

A DRS is described more specifically below. A DRS is used to demodulate data. In multiple input/output antennas transmission, a precoding weight used for a specific UE is combined with a transport channel transmitted in each transmission antenna when a UE receives a reference signal, and is used without any change in order to estimate a corresponding channel.

The 3GPP LTE system (e.g., Release-8) supports a maximum of 4 transmission antennas, and a DRS for rank 1 beamforming is defined. The DRS for rank 1 beamforming also indicates a reference signal for an antenna port index 5.

A rule that a DRS is mapped to a resource block is defined as follows. Equation 2 shows the case of a normal cyclic prefix, and Equation 3 shows the case of an extended cyclic prefix.

$$\begin{matrix} k = ( {k}^{′} ) mod {N}_{sc}^{RB} + {N}_{sc}^{RB} \cdot {n}_{PRB} & [ Equation 2 ] \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} & \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} & \\ {l}^{′} = \{ \begin{matrix}0 , 1 & if {n}_{s} mod 2 = 0 \\ 2 , 3 & if {n}_{s} mod 2 = 1\end{matrix} & \\ {m}^{′} = 0 , 1 , … , 3 {N}_{R B}^{PDSCH} - 1 & \\ {v}_{shift} = {N}_{ID}^{cell} mod 3 & \\ k = ( {k}^{′} ) mod {N}_{sc}^{RB} + {N}_{sc}^{RB} \cdot {n}_{PRB} & [ Equation 3 ] \\ {k}^{′} = \{ \begin{matrix}3 {m}^{′} + {v}_{shift} & if l = 4 \\ 3 {m}^{′} + ( 2 + {v}_{shift} ) mod 3 & if l = 1\end{matrix} & \\ l = \{ \begin{matrix}4 & {l}^{′} ∈ \{ 0 , 2 \} \\ 1 & {l}^{′} = 1\end{matrix} & \\ {l}^{′} = \{ \begin{matrix}0 & if {n}_{s} mod 2 = 0 \\ 1 , 2 & if {n}_{s} mod 2 = 1\end{matrix} & \\ {m}^{′} = 0 , 1 , … , 4 {N}_{R B}^{PDSCH} - 1 & \\ {v}_{shift} = {N}_{ID}^{cell} mod 3 & \end{matrix}$$

In Equation 1 to Equation 3, k and p indicates a subcarrier index and an antenna port, respectively. N_{RB}^{DL}, ns, and N_{ID}^{cell} indicate the number of RBs allocated to the downlink, the number of slot indices, and the number of cell IDs. The position of an RS is different depending on a v_{shift} value from a viewpoint of the frequency domain.

In Equations 2 and 3, k and l indicates a subcarrier index and a symbol index, respectively, and p indicates an antenna port. N_{sc}^{RB} indicates a resource block size in the frequency domain and is expressed as the number of subcarriers. n_{PRB} indicates the number of physical resource blocks. N_{RB}^{PDSCH} indicates the frequency band of a resource block for PDSCH transmission. ns indicates a slot index, and N_{ID}^{cell} indicates a cell ID. mod indicates modulo operation. The position of a reference signal is different depending on the v_{shift} value in the frequency domain. Since v_{shift} depends on a cell ID, the position of a reference signal has various frequency shifts depending on a cell.

Sounding Reference Signal (SRS)

An SRS is chiefly used for channel quality measurement in order to perform frequency-selective scheduling in the uplink, and is not related to the transmission of uplink data and/or control information. However, the present invention is not limited thereto, and the SRS may be used for improving power control or various other objects for supporting various start-up functions of a UE that have not recently been scheduled. For example, the start-up function may include an initial modulation and coding scheme (MCS), initial power control for data transmission, timing advance and frequency semi-selective scheduling. In this case, frequency semi-selective scheduling means scheduling for selectively allocating a frequency resource to the first slot of a subframe and allocating a frequency resource in such a way as to pseudo-randomly jump to another frequency in the second slot of the subframe.

Furthermore, an SRS may be used to measure downlink channel quality, assuming that a radio channel is reciprocal between the uplink and the downlink. Such an assumption is particularly valid in a time division duplex (TDD) system in which the uplink and the downlink share the same frequency spectrum and are separated in the time domain.

The subframes of an SRS transmitted by any UE within a cell may be indicated by a cell-specific broadcasting signal. A 4-bit cell-specific “srsSubframeConfiguration” parameter indicates an array of 15 possible subframes in which an SRS may be transmitted through each radio frame. In accordance with such arrays, flexibility for the adjustment of SRS overhead is provided according to a deployment scenario.

In the 16-th array of the arrays, the switch of an SRS is fully off within a cell, which is suitable for a serving cell that chiefly serves high-speed UEs.

FIG. 14 illustrates an uplink subframe including a sounding reference signal symbol in a wireless communication system to which the present invention may be applied.

Referring to FIG. 14, an SRS is always transmitted through the last SC-FDMA symbol on an arrayed subframe. Accordingly, an SRS and a DMRS are located in different SC-FDMA symbols.

PUSCH data transmission is not permitted in a specific SC-FDMA symbol for SRS transmission. As a result, if sounding overhead is the greatest, that is, although an SRS symbol is included in all of subframes, sounding overhead does not exceed about 7%.

Each SRS symbol is generated by a base sequence (random sequence or sequence set based on Zadoff-Ch (ZC)) regarding a given time unit and a frequency band. All of UEs within the same cell use the same base sequence. In this case, SRS transmission from a plurality of UEs within the same cell in the same frequency band and the same time become orthogonal and distinguished by the different cyclic shifts of a base sequence.

Since a different base sequence is allocated to each cell, SRS sequences from different cells may be distinguished, but orthogonality between different base sequences is not guaranteed.

Coordinated Multi-Point (COMP) Transmission and Reception

In line with the needs of LTE-advanced, CoMP transmission was proposed for performance improvement of a system. A CoMP is also called co-MIMO, collaborative MIMO or network MIMO. A CoMP is expected to improve performance of a UE located in a cell boundary and to improve the throughput of an average cell (sector).

In general, inter-cell interference deteriorates performance of a UE located in a cell boundary and average cell (sector) throughput a multi-cell environment in which a frequency reuse index is 1. In order to reduce inter-cell interference, a simple passive method, such as fractional frequency reuse (FFR), has been applied in the LTE system so that a UE located in a cell boundary has proper performance throughput in an interference-limited environment. However, a method of reusing inter-cell interference or reducing inter-cell interference as the desired signal of a UE instead of reducing the use of frequency resources per cell becomes a better gain. In order to achieve the aforementioned object, a CoMP transmission scheme may be applied.

CoMP schemes that may be applied to the downlink may be classified into a joint processing (JP) scheme and a coordinated scheduling/beamforming (CS/CB) scheme.

In the JP scheme, data may be used in each point (eNB) of a CoMP unit. The CoMP unit means a set of eNBs used in the CoMP scheme. The JP scheme may be divided into a joint transmission scheme and a dynamic cell selection scheme.

The joint transmission scheme means a scheme in which signals are transmitted by some or all of a plurality of points at the same time through a PDSCH in a CoMP unit. That is, data transmitted to a single UE may be transmitted by a plurality of transmission points at the same time. Quality of a signal transmitted to a UE can be improved regardless of whether it is coherently or non-coherent, and interference with another UE can be actively removed through the joint transmission scheme.

The dynamic cell selection scheme means a scheme in which a signal is transmitted by a single point in a CoMP unit through a PDSCH. That is, data transmitted to a single UE on a specific time is transmitted by a single point, and another point within the CoMP unit does not transmit data to the UE. A point that transmits data to a UE may be dynamically selected.

In accordance with the CS/CB scheme, a CoMP unit performs beamforming through cooperation for data transmission to a single UE. That is, data is transmitted to the UE only in a serving cell, but user scheduling/beamforming may be determined through cooperation between a plurality of cells within the CoMP unit.

In the case of the uplink, CoMP reception means the reception of a signal transmitted by cooperation between a plurality of points that are geographically separated. A CoMP scheme that may be applied to the uplink may be divided into a joint reception (JR) scheme and a coordinated scheduling/beamforming (CS/CB) scheme.

The JR scheme means a scheme in which a CoMP unit receives a signal transmitted by some or all of a plurality of points through a PDSCH. In the CS/CB scheme, a signal transmitted through a PDSCH is received only in a single point, but in the user scheduling/beamforming, a signal may be determined through cooperation between a plurality of cells within a CoMP unit.

Cross-CC Scheduling and E-PDCCH Scheduling

In the existing 3GPP LTE Rel-10 system, if a cross-CC scheduling operation in an aggregation situation of a plurality of component carriers (CC=(serving) cells) is defined, one CC (i.e. scheduled CC) may be previously configured to receive DL/UL scheduling (i.e., a DL/UL grant PDCCH for a corresponding scheduled CC can be received) from only a specific one CC (i.e. scheduling CC).

The corresponding scheduling CC may basically perform DL/UL scheduling on its own scheduling CC.

In other words, all of the SSs of a PDCCH that schedule scheduling/scheduled CCs having a cross-CC scheduling relation may be present in the control channel region of a scheduling CC.

Meanwhile, in the LTE system, in an FDD DL carrier or TDD DL subframes, the first n OFDM symbols of the subframe are used for the transmission of a PDCCH, PHICH or PCFICH, that is, a physical channel for various types of control information transmission, and the remaining OFDM symbols are used for PDSCH transmission.

In this case, the number of symbols used for control channel transmission in each subframe is transmitted to a UE dynamically through a physical channel, such as a PCFICH, or in a semi-static manner through RRC signaling.

In this case, characteristically, an n value may be set up to a maximum of 4 symbols in 1 symbol depending on subframe characteristics and system characteristics (FDD/TDD, a system bandwidth, etc.).

Meanwhile, in the existing LTE system, a PDCCH, that is, a physical channel for transmitting DL/UL scheduling and various types of control information, has a limit because it is transmitted through limited OFDM symbols.

Accordingly, an enhanced PDCCH (i.e. E-PDCCH) in which a PDCCH and a PDSCH are multiplexed more freely according to the FDM/TDM scheme instead of a control channel transmitted through an OFDM symbol separated from the PDSCH may be introduced.

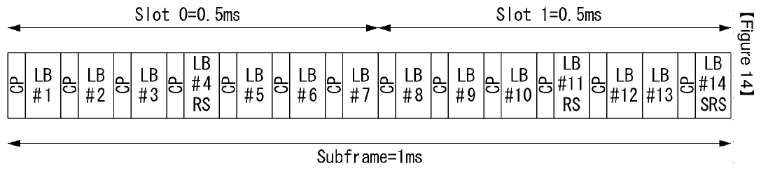

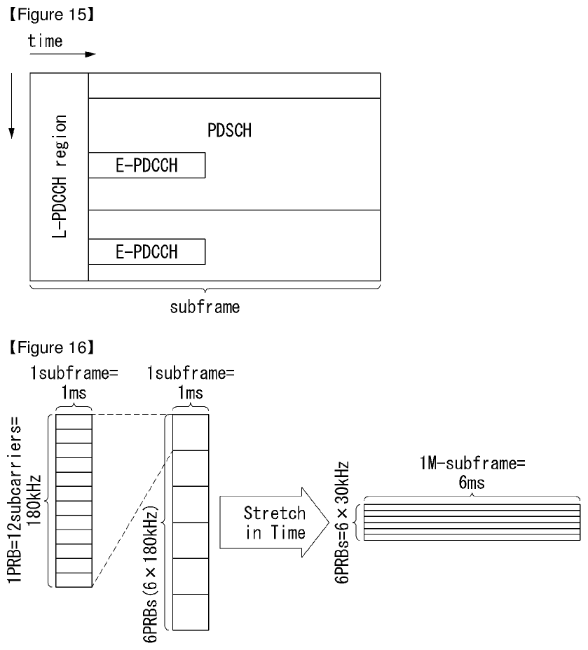

FIG. 15 is a diagram showing an example in which a legacy PDCCH, a PDSCH and an E-PDCCH are multiplexed.

In this case, the legacy PDCCH may be expressed as an L-PDCCH.

General Narrow Band (NB)-LTE System

Hereinafter, an NB-LTE (or NB-IoT) system is described.

The uplink of NB-LTE is based on SC-FDMA. This is a special case of SC-FDMA, and can make flexible the bandwidth allocation of a UE including single tone transmission.

One important aspect of uplink SC-FDMA is to synchronize times for a plurality of co-scheduled UEs so that an arrival time difference in an eNB is located within a cyclic prefix (CP).

Ideally, uplink 15 kHz subcarrier spacing must be used in NB-LTE, but time-accuracy that may be achieved when detecting a PRACH from UEs in a poor coverage condition must be taken into consideration.

Accordingly, CP duration needs to be increased.

One method for achieving this object is to reduce subcarrier spacing for an NB-LTE M-PUSCH to 2.5 kHz by dividing the 15 kHz subcarrier spacing by 6.

Another motivation for reducing the subcarrier spacing is to permit a high level of user multiplexing.

For example, one user is basically allocated to one subcarrier.

This is more effective for UEs having a very limited coverage condition, such as UEs whose system capacity is increased because a plurality of UEs uses maximum TX power at the same time, but which do not have a gain that a bandwidth is allocated.

SC-FDMA is used for the transmission of a plurality of tones in order to support a higher data rate along with an additional PAPR reduction technology.

Uplink NB-LTE includes three basic channels, including an M-PRACH, an M-PUCCH and an M-PUSCH.

Regarding the design of the M-PUCCH, at least three alternatives are being discussed as below.
One tone at each edge of a system bandwidth
UL control information transmission on the M-PRACH or M-PUSCH
Not having a dedicated UL control channel

Time-Domain Frame and Structure

In the uplink of NB-LTE having the 2.5 kHz subcarrier spacing, a radio frame and subframe are defined as 60 ms and 6 ms, respectively.

As in the downlink of NB-LTE, an M-frame and an M-subframe are identically defined in the uplink of NB-LTE.

FIG. 16 is a diagram showing that how the uplink numerology has been stretched in a time domain.

An NB-LTE carrier includes 6 PRBs in the frequency domain, and each NB-LTE PRB includes 12 subcarriers.

An uplink frame structure based on 2.5 kHz subcarrier spacing is shown in FIG. 17.

FIG. 16 shows an example of the uplink numerology stretched in the time domain when subcarrier spacing is reduced from 15 kHz to 2.5 kHz.

FIG. 17 is a diagram showing an example of time units for the uplink of NB-LTE based on 2.5 kHz subcarrier spacing.

Physical Random Access Channel (PRACH)

In NB-LTE, random access provides a plurality of objects, such as initial access when establishing a radio link, and a scheduling request.

A main object of the random access from other objects is to achieve uplink synchronization. This is important to maintain uplink orthogonality.

In NB-LTE, new random access preambles are designed for NB-LTE due to a reduced bandwidth.

The remaining random access procedures comply with the process in LTE (3GPP 36.300).

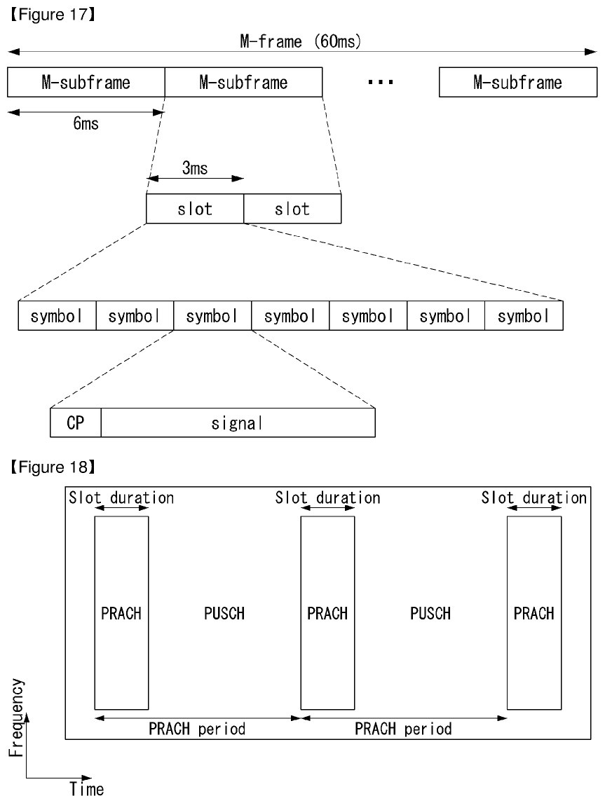

If a dedicated M-PUCCH is not present, the multiplexing of an M-PRACH along with an M-PUSCH in NB-LTE is shown in FIG. 18.

M-PRACH time-frequency resources may be configured by an eNB.

If necessary, the M-PUSCH may be multiplexed with the M-PRACH in an M-PRACH slot.

In the uplink of NB-LTE, eight 2.5 kHz edge subcarriers are reserved for an M-PUSCH.

If an M-PUCCH is configured, six edge subcarriers are reserved, and a 160 kHz bandwidth is left for an M-PRACH.

FIG. 18 is a diagram showing an example in which an M-PRACH is multiplexed with an M-PUSCH.

Preambles based on Zadoff-Chu sequences are used in the NB-LTE M-PRACH preamble design and have a length of 491.

Subcarrier spacing used in the NB-LTE M-PRACH is 312.5 Hz.

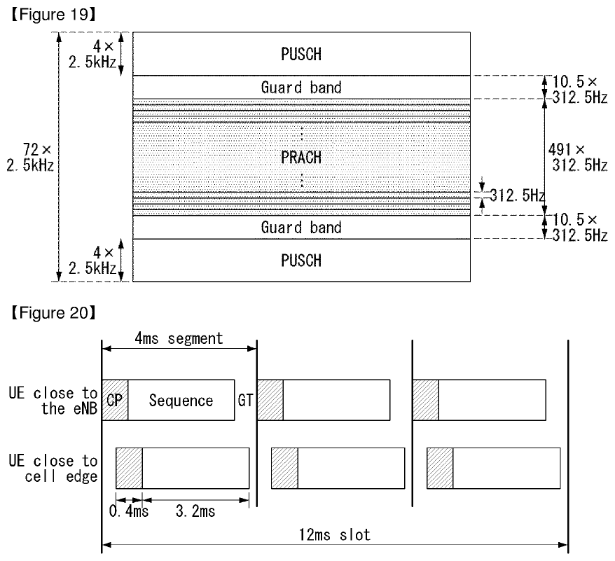

They are well shown in FIG. 19.

Moreover, as in LTE, the same number of preambles (64 preambles) may be used for NB-LTE.

FIG. 19 is a diagram showing an M-PRACH preamble length and subcarrier spacing.

An M-PRACH slot interval and cycle may be set depending on a load and cell size. Such setting is provided as follows.

Preamble sequence duration having 312.5 Hz subcarrier spacing is 3.2 ms.

In NB-LTE, a basic scheduling unit is an M-subframe of 6 ms.

Two M-subframes include one M-PRACH slot of 12 ms.

Each 12 ms M-PRACH slot is additionally divided into three 4-ms M-PRACH segments.

Since the preamble sequence duration is 3.2 ms, the remaining resource is 0.8 ms for a CP and a guard time.

A CP length of 0.4 ms is selected to maximize coverage.

FIG. 20 is a diagram showing the CP of an M-PRACH and the dimensioning of a guard time.

The CP length of 0.4 ms can solve a cell size up to 60 km.

Three M-PRACH formats are defined as in Table 6 based on the CP and guard time dimensioning of FIG. 20.

The formats 0, 1 and 2 are used for basic coverage, robust coverage and extreme coverage in each NB-LTE.

With respect to UEs located in basic coverage (preamble format 0), one M-PRACH segment is sufficient to transmit the preambles of corresponding UEs.

With respect to UEs located in robust coverage (preamble format 1), the transmission of each preamble is repeated six times and resultantly occupies two 12 ms M-PRACH slots.

With respect to UEs located in extreme coverage (preamble format 2), the transmission of each preamble is repeated 18 times and resultantly requires six 12 ms M-PRACH slots.

Table 6 is a table showing an example of the M-PRACH formats.

TABLE 6

| Format | Tcp (ms) | Tseq (ms) | Number of preambles |
|---|---|---|---|
| 0 | 0.4 | 3.2 | N0 |
| 1 | 0.4 | 3.2 | N1 |
| 2 | 0.4 | 3.2 | N2 |

M-PRACH Configuration

The simultaneous preamble transmission of UEs (or users) located in different coverage classes may generate a potential near-far problem.

In order to reduce such a problem, the preamble transmissions of UEs in different coverage classes are time-multiplexed in NB-LTE.

Moreover, in order to avoid potential and consistent inter-cell interference, the preamble transmission of UEs in adjacent cells may be preferred to be separated in the time domain.

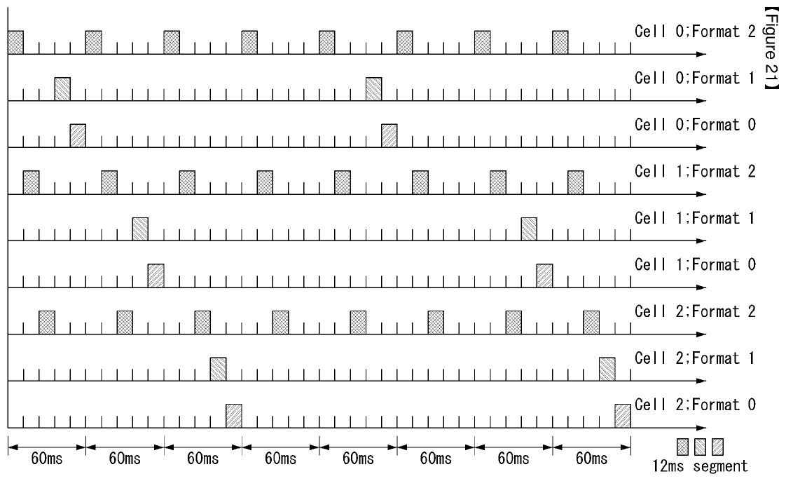

FIG. 21 shows an example of a random access resource configuration that satisfies time multiplexing requirements.

Referring to FIG. 21, the cycles of random access resources for the preamble formats 0, 1 and 2 are 240 ms, 240 ms, and 60 ms, respectively.

As shown in FIG. 21, in a 480 ms time window, two M-PRACH slots are configured for the preamble format 0, two M-PRACH slots are configured for the preamble format 1, and eight M-PRACH slots are configured for the preamble format 2.

In summary, 30% uplink resources are configured for random access. A system may configure smaller random access resources if a load is reduced.

FIG. 21 is a diagram showing an example of a random access resource configuration.

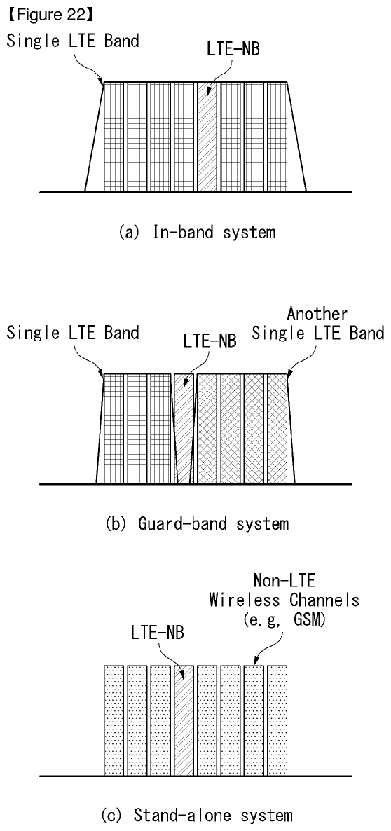

FIG. 22 is a diagram showing an example of the operating system of an NB LTE system to which a method proposed by this specification may be applied.

Specifically, FIG. 22a shows an in-band system, FIG. 22b shows a guard-band system, and FIG. 22c shows a stand-alone system.

The in-band system may be expressed as an in-band mode, the guard-band system may be expressed as a guard-band mode, and the stand-alone system may be expressed as a stand-alone mode.

The in-band system of FIG. 22a refers to a system or mode in which a specific 1 RB within a legacy LTE band is used for NB-LTE (or LTE-NB) and may be operated by allocating some resource blocks of an LTE system carrier.

The guard-band system of FIG. 22b refers to a system or mode in which NB-LTE is used for the space reserved for the guard band of a legacy LTE band, and may be operated by allocating the guard-band of ah LTE carrier not used as an RB in the LTE system.

The legacy LTE band has a guard band of at least 100 KHz at the last of each LTE band.

In order to use 200 KHz, two non-contiguous guard bands may be used.

The in-band system and the guard-band system show structures in which NB-LTE coexists within the legacy LTE band.

In contrast, the stand-alone system of FIG. 22c refers to a system or mode independently configured from a legacy LTE band and may be operated by separately allocating a frequency band (GSM carrier reallocated in the future) used in the GERAN.

In a next-generation communication system after LTE(-A) system, a scenario in which cheap and low-specification UEs are configured at a very high density and information obtained from sensors is transmitted and received through data communication is taken into consideration.

Such a UE is collectively called a machine type communication (MTC) UE.

For example, the uplink of a wireless communication system capable of such a scenario may operate as the frequency division multiple access (FDMA) or OFDMA/SC-FDMA scheme using a cellular network.

In this case, it is necessary to define an initial access process for properly selecting or managing a plurality of UEs using limited resources or a narrow band (NB) and a transport channel corresponding to the initial access process.

The initial access process may be defined so that a UE transmits a random access channel (RACH) sequence in sub-channel units properly divided on a system bandwidth.

Accordingly, an eNB can detect and identify corresponding UEs, and must be able to be synchronized with a corresponding UE.

That is, this specification proposes a method in which PRACHs (or random access signals) transmitted by a plurality of UEs (or users) can be multiplexed and transmitted and a method in which a PRACH and the transmission data (e.g., PUSCH) of a UE can be multiplexed and transmitted.

### First Embodiment: Method of Multiplexing RACHs of Different UEs

First, a method of multiplexing RACHs transmitted by a plurality of UEs is described.

A UE selects one of a number of RACH sequences predefined in a system when attempting initial access to an eNB, and uses the selected PRACH sequence.

For example, in the case of the LTE(-A) system, the number of predefined RACH sequences is 64.

If UEs greater than a number defined in a system attempt initial access to an eNB, a collision occurs.

Furthermore, in order to operate a network using a small number of base stations, an Internet of Thing (IoT) system may support coverage of a wide band.

If the IoT system supports coverage of a wide band, a plurality of UEs having different coverage may coexist in the IoT network or the IoT system.

In general, a UE in a very deep indoor may have a high coverage class, but the number of UEs may be said to be small.

In contrast, UEs having better coverage may be said to occupy a larger number in the IoT network.

However, in the IoT network, the number of UEs may be variable depending on the coverage class.

Furthermore, UEs having different coverage classes may share a PRACH resource through a code division multiplexing (CDM) scheme. However, since performance of the corresponding CDM scheme may be deteriorated by the near-far effect, it is not preferred that different UEs share a PRACH resource through the CDM scheme.

Furthermore, a method of sharing a PRACH resource using the time division multiplexing (TDM) scheme for each coverage class of a UE may be taken into consideration, but the TDM scheme may derive the delay of PRACH transmission.

Accordingly, it is necessary to take into consideration a structure in which UEs having different coverage classes share the FDM scheme in such a way as to share a PRACH resource.

Hereinafter, a method of sharing a PRACH resource using the FDM scheme for each coverage class of a UE is described in detail through the first embodiment.

That is, in order to reduce a collision probability for the PRACH transmission of UEs having different coverage classes, a resource region capable of transmitting a PRACH sequence may be separated into two or more regions.

For convenience of description, the resource region has been illustrated as being separated into two PRACH resources, but is not limited thereto. A method proposed by this specification may also be applied to a case where a resource region is separated into two or more PRACH resources.

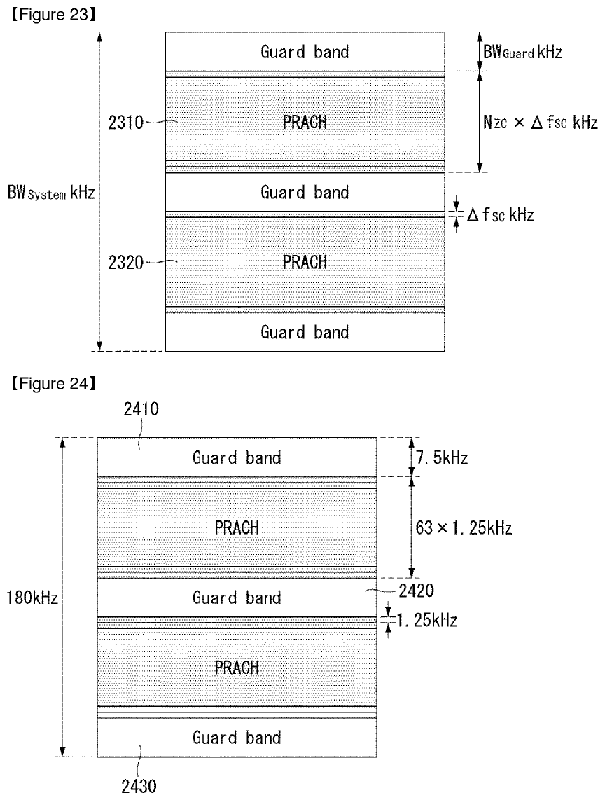

FIG. 23 is a diagram showing an example of a method of configuring PRACH resources, which is proposed by this specification.

That is, FIG. 23 shows PRACH resources separated into two resource regions. The resource regions may be expressed as a first PRACH resource region and a second PRACH resource region.

Referring to FIG. 23, a PRACH sequence may be transmitted through any one of the two divided PRACH resource regions 2310 and 2320.

In this case, an eNB may notify a user (or UE) whether the PRACH sequence will be transmitted through which resource region through physical layer signaling or higher layer signaling, or the UE may transmit a PRACH sequence through any one of the divided resource regions 2310 and 2320 regarding whether the PRACH sequence will be transmitted through which resource region.

When a PRACH resource region is divided into a specific number, if the corresponding PRACH resource region is configured to satisfy only a length to the extent that a sufficient number of RACH sequences can be generated, a collision probability which may occur when UEs perform initial access can be reduced compared to a case where one PRACH resource region is configured.

Alternatively, in order to maintain a PRACH sequence length, a method of increasing the transmission of a PRACH time may also be taken into consideration.

Furthermore, as in FIG. 23, an RACH sequence may be divided into a plurality of groups within each of the resource regions 2310 and 2320 divided into two resource regions, and a specific group may be selected according to a specific criterion for each user (or each UE).

That is, a collision probability which may occur when UEs perform initial access can be reduced by placing a difference between the candidate groups of an RACH sequence which may be selected for each user or each UE.

For example, after 64 RACH sequences are divided into two groups each one having 32 PRACH sequences, any one of the two groups may be selected through a modulo 2 operation results value of a unique identifier (ID) of each UE, and an RACH sequence may be selected within the selected group.

Alternatively, an RACH sequence group may be configured according to a coverage class.

Alternatively, if the congestion of PRACHs is generated, PRACH transmission may be limited to until a PRACH transmission group is changed in at least next master information block (MIB) or system information block (SIB) with respect to UEs belonging to a specific group through an MIB or SIB.

For example, UEs may be divided into K groups (divided into UE ID % K groups) based on a UE ID or the ID of a USIM. An eNB may notify corresponding UEs whether PRACH transmission is possible for each bit for each group through an MIB or SIB.

For example, it may be assumed that a UE belonging to an I-th group cannot perform PRACH transmission if an i-th bit is not triggered (e.g., the i-th bit=0).

This is for dynamically adjusting the probability of PRACH transmission. The group of a UE may be classified for each coverage class, may be classified as a group of UEs using a PRACH resource, or may be classified using the ID of a UE.

However, such a limit may not be applied in transmitting a PRACH through retransmission (or PRACH retransmission) or transmitted by the triggering of a network or in transmitting a PRACH of a contention-based PUSCH form.

Furthermore, in order to dynamically adjust the amount of PRACH resources, a network may semi-statically allocate a PRACH resource (e.g., a PRACH resource of 6 msec is allocated every 20 msec), and may allocate an additional PRACH resource to a UE group or each UE.

Dynamic PRACH resources allocation may be adjusted using a transmission probability.

Such a transmission probability may be a value set by a network or may be a value adjusted depending on whether the PRACH transmission of a UE is successful.

If the transmission of a PRACH is not performed by the transmission probability, a physical layer can prevent an increase of unnecessary power ramping or retransmission counter by indicating a higher layer.

When performing PRACH transmission, a UE may transmit the PRACH assuming maximum power. If PRACH transmission fails, a UE may reduce congestion by reducing the transmission probability in order to reduce a retransmission opportunity.

Furthermore, a PRACH resource may be separately configured for initial transmission and retransmission.

FIG. 24 is a diagram showing another example in which a PRACH resource has been separated into two resource regions, which is proposed by this specification.

Specifically, FIG. 24 is a detailed example in which a PRACH resource has been configured into two PRACH resource regions by taking into consideration the subcarrier spacing of an LTE system.

Furthermore, FIG. 24 shows an example of a PRACH structure which may be applied to the aforementioned NB-IoT or NB-LTE system.

In the case of FIG. 24, a guard band between the two PRACH resources has been configured. If subcarrier spacing between different PRACH resources is the same, a guard band between PRACH resources may not be configured.

The system bandwidth of the NB-IoT system is defined as 180 kHz corresponding to 1 RB.

That is, an example in which a PRACH resource region includes two resource regions by applying the method proposed by this specification to the NB-IoT system is shown in FIG. 24.

The subcarrier spacing of FIG. 24 is only an example, and may be identically applied to subcarrier spacing of a different value.

Referring to FIG. 24, two PRACH resource regions may be configured on a system bandwidth of 180 kHz using a Zadoff-Chu sequence of a 63 length in subcarrier spacing of 1.25 kHz, but a guard band 2420 of 7.5 kHz may be located between both ends 2410 and 2430 in the frequency axis and the PRACH regions.

Interference between PRACHs and interference with another existence system can be reduced through such a guard band.

However, if the CP length of a PRACH is sufficiently large as described above, the guard band between both ends in the frequency axis and the PRACH regions may not be configured.

In this case, a sequence for a primary synchronization signal (PSS) used for synchronization upon initial access in the LTE system or a sidelink synchronization signal (SLSS) transmitted by a UE in a device-to-device (D2D) may be used as a Zadoff-Chu sequence of a 63 length.

However, a minimum transmission unit may not be identical with 1 ms, that is, the transmission unit (e.g., TTI) of the LTE system if a cyclic prefix (CP) is incorporated into the subcarrier spacing of the LTE system by taking into consideration a cell radius, that is, a target of the NB-IoT system, and the influence of delay spread.

In this case, the minimum transmission unit may become a 1 ms unit or a unit of a multiple of 1 ms by adding a proper guard time (GT).

As described above, if a plurality of PRACH resources has been configured on the frequency, the length of a PRACH sequence used in each PRACH resource may be different.

For example, in the case of a UE having a low coverage class, it is expected that the number of UEs within corresponding coverage is large. Accordingly, the length of a sequence may be set to support many UEs.

Furthermore, in the case of a UE having a relatively high coverage class, it is difficult to multiplex several UEs because the length of a sequence is short, but the sequence may be used to relatively reduce the transmission time.

A coverage class may be mapped to several PRACH resources configured as described above, and a PRACH sequence and/or format which may be used in a coverage class may be differently configured.

Such a configuration method may be performed through a higher layer or an MIB/SIB.

Furthermore, such a scheme may be configured although several PRACH resources are subjected to TDM, and may be differently configured depending on the population of UEs in each piece of coverage which is actually expected in a network.

As described above, if the basic format of a sequence or PRACH is different, a UE determines a format and transmission resources based on its own selected coverage class.

In this case, in a method for the UE to select its own coverage class, the UE may select its own coverage class through measurement (e.g., PSS/SSS detection time) using a PSS/SSS or through the reception of an SIB.

### Second Embodiment: Method of Multiplexing RACH and PUSCH

A method of multiplexing an RACH and PUSCH between UEs is described below.

As described in the first embodiment (the description related to FIGS. 23 and 24), the second embodiment provides a method using some 2510 of two or more PRACH resource regions 2510 and 2520 as a PUSCH.

That is, if some of the two or more PRACH resource regions is used as a PUSCH, the data transmission of a UE in the corresponding PUSCH region 2510 may be performed by receiving resource allocation for corresponding data transmission through downlink control information (DCI) from an eNB.

For example, in order to transmit data in some region of the PRACH resources of FIGS. 23 and 24, a specific user or a specific UE may receive only one tone allocated thereto at one point from an eNB or may receive several contiguous tones allocated thereto at the same time.

Furthermore, an eNB may divide the region of tones that may be used for each group depending on the coverage class of a user (or UE) and allocate them to the UEs.

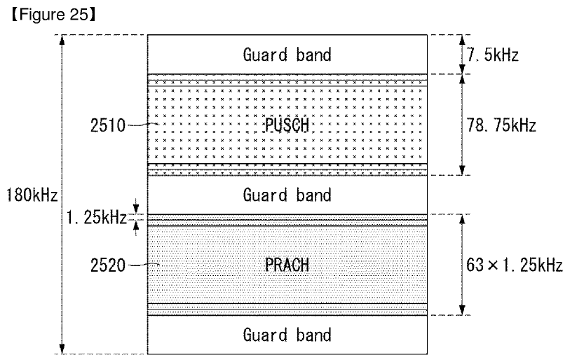

FIG. 25 is a diagram showing an example of a multiplexing method between a PUSCH and a PRACH, which is proposed by this specification.

That is, referring to FIG. 25, a portion 2510 indicated as a “PUSCH” in FIG. 25 is a PRACH resource region and also a region capable of data transmission, and it includes a total of 63 tones (78.75 kHz/1.25 kHz).

The total of 63 tones is grouped for each coverage class {8, 10, 15, or 30} and allocated, and {1, 2, 3, 6} contiguous tones may be allocated for each coverage class.

As described above, if the total of 63 tones is allocated by taking into consideration the coverage class, a user having a high coverage class occupies an excessively long time channel, thereby being capable of reducing a collision upon initial access and also preventing unbalanced resource allocation between coverage classes.

### Third Embodiment: PRACH Transmission Method According to Coverage Class

The third embodiment provides a PRACH transmission method according to the coverage class of a UE.

In a wireless communication system, the position of a UE (or user) may be various based on a specific eNB.

Accordingly, since the reception state of a signal is excellent or poor depending on the position of a UE, the position of a UE may be divided into a plurality of groups and a PRACH signal may be adaptively configured.

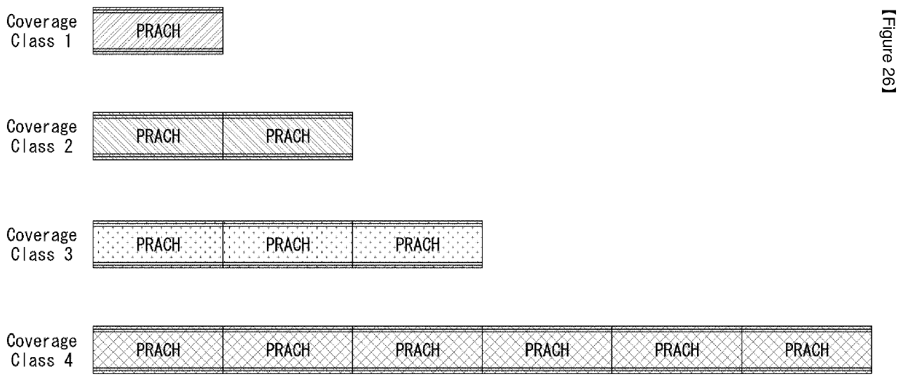

FIG. 26 is a diagram showing an example of a PRACH transmission method according to a coverage class, which is proposed by this specification.

That is, FIG. 26 shows a configuration in which UEs are basically divided into 4 coverage classes and the number of PRACH transmission subframes is different for each coverage class.

From FIG. 26, it may be seen that UEs corresponding to the coverage class 1 transmit a PRACH through one transmission subframe and UEs corresponding to the coverage classes 4 transmit PRACHs through six subframes.

FIG. 27 is a diagram showing another example of a PRACH transmission method according to a coverage class, which is proposed by this specification.

That is, in the case of FIG. 27, a plurality of coverage classes may be configured to use one PRACH type.

In this case, a PRACH type may be a value that identifies the number of subframes in which UEs corresponding to a plurality of coverage classes can transmit a PRACH.

Specifically, the PRACH transmission methods of FIGS. 26 and 27 may be configured contiguously or separately in the time axis.

An eNB may notify a UE of such a configuration through physical layer signaling or higher layer signaling.

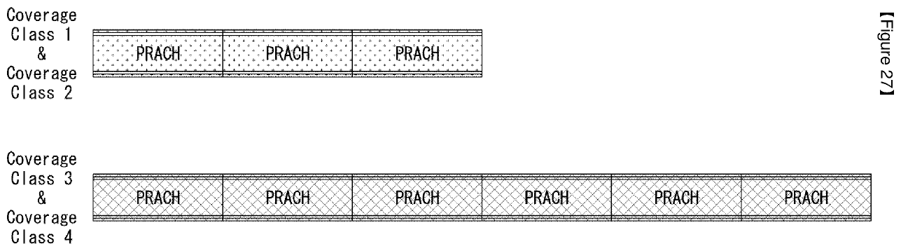

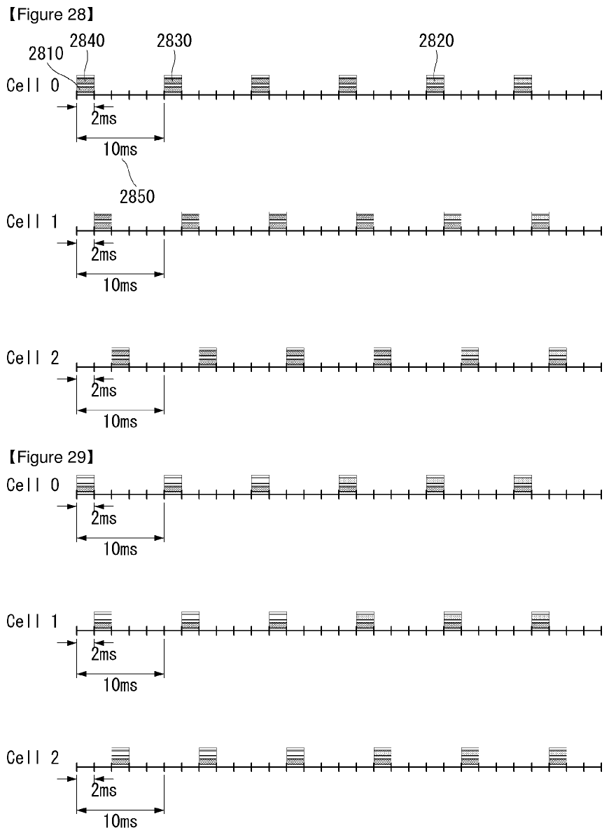

FIG. 28 is a diagram showing an example in which PRACH resources have been spaced and configured in a time axis, which is proposed by this specification.

FIG. 28 shows a PRACH resource configuration in which RACH scheduling of a 2 ms unit has been assumed.

It may be seen that each coverage class is repeated in different frequency (1, 2, 3 or 6 times) for 60 ms and transmitted.

In FIG. 28, it may be seen that UEs corresponding to a first coverage class 2810 repeatedly transmit PRACHs six times, UEs corresponding to a second coverage class 2820 repeatedly transmit PRACHs three times, UEs corresponding to a third coverage class 2830 repeatedly transmit PRACHs twice, and UEs corresponding to a fourth coverage class 2840 repeatedly transmit PRACHs once.

Furthermore, spacing between PRACH resources may be configured randomly so that the PRACH resources do not overlap between cells.

From FIG. 28, it may be seen that spacing 2850 between PRACH resources is 10 ms.

Several sets of such random intervals may be produced, and which one of the sets will be used may be designated by a network.

For example, in a specific set, spacing between PRACH resources may be (10 msec, 25 msec, 15 msec, 20 msec). In another set, the spacing may be (10 msec, 20 msec, 40 msec, 10 msec).

As described above, to randomly configure the spacing between PRACH resources is for preventing the PRACH resources from always overlapping at the same timing and for improving PRACH reception performance of an eNB.

As in the aforementioned second embodiment, some PRACH region needs to be reserved in order to multiplex a PUSCH and a PRACH using some of PRACH resources as a PUSCH.

That is, an example in which the method of the second embodiment and the PRACH resource configuration method of FIG. 28 are together incorporated is shown in FIG. 29.

FIG. 29 is a diagram showing another example in which PRACH resources have been spaced and configured in a time axis, which is proposed by this specification.

FIG. 29 shows a form in which only two PRACH types are used as in FIG. 27 and the remaining PRACH resource region is reserved for PUSCH transmission.

In this case, an expression in which some of a PRACH resource region is reserved for PUSCH transmission may be construed as being an expression in which some of the PRACH resource region is punctured.

An eNB may notify a UE of a change of a PRACH resource configuration through physical layer signaling or higher layer signaling.

The aforementioned methods may be applied to a case where a system to which the corresponding methods may be applied includes several narrow bands other than one narrow band (e.g., 180 kHz) without any change.

That is, a UE may change a current narrow band into another narrow band and operate in the same manner.

If a PRACH resource has been configured as described above, that is, in a subframe in which a PRACH resource has been configured, it may be considered that the transmission of a PUSCH is not generated.

That is, in the case where the transmission of a PUSCH is generated in a plurality of subframes, if a PRACH resource overlaps in the middle, PUSCH transmission may be skipped in a subframe in which a PUSCH and a PRACH overlap.

PRACH Transmission Method Using SC-FDMA

As another example of PRACH transmission, a method of transmitting a PRACH using SC-FDMA may be taken into consideration.

For example, if about 48 subcarriers can be produced within 200 KHz, only subcarriers of about ⅓ may be used for PRACH transmission by taking into consideration that timing advance is not configured.

If about 48 subcarriers are produced within 200 kHz, subcarrier spacing may be about 3.75 kHz.

In this case, some subcarriers may be used as a gap (or guard band).

That is, a different subcarrier (or some subcarriers) between subcarriers which may be used as a PRACH may be used as a gap (or guard band).

Accordingly, a UE may select one PRACH resource of available subcarriers and transmit a PRACH.

In this case, a PRACH format is the same as a PUSCH or a form in which a DM-RS or preamble is additionally transmitted prior to the PUSCH may be taken into consideration.

This method (the PRACH transmission method using SC-FDMA) may be said to be more effective if subcarrier spacing is reduced and a CP length is relatively long.

Furthermore, the aforementioned PRACH resource configuration and transmission method (the first embodiment to the third embodiment) may be identically applied to a PRACH transmission method using SC-FDMA.

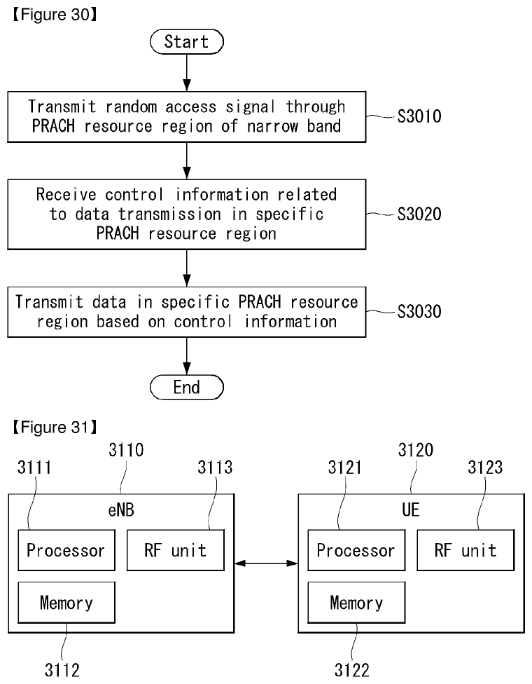

FIG. 30 is a flowchart showing an example of a method of transmitting a random access signal in an NB-LTE system, which is proposed by this specification.

First, a UE transmits a random access signal to an eNB through a physical random access channel (PRACH) resource region of a narrow band (NB) having a system bandwidth of 180 kHz (S3010).

In this case, the UE may be an MTC UE, but is not limited thereto.

In this case, the PRACH resource region includes a first PRACH resource region and a second PRACH resource region.

Furthermore, each of the first PRACH resource region and the second PRACH resource region may include at least one subcarrier; each one has specific subcarrier spacing.

The specific subcarrier spacing may be 1.25 kHz, 3.75 kHz, or 15 kHz.

If the specific subcarrier spacing is 3.75 kHz, a case where 48 subcarriers are configured in an 180 KHz system bandwidth corresponding to 1 RB may be assumed.

Furthermore, any one of the first PRACH resource region and the second PRACH resource region may be used for the data transmission of the UE.

Furthermore, the first PRACH resource region and the second PRACH resource region are separated in the frequency domain.

Furthermore, the PRACH resource region may include one or more PRACH resources separated depending on the coverage class of a UE.

In this case, the one or more PRACH resources may include different PRACH sequences and/or different PRACH preamble formats.

In this case, the UE may receive information related to the one or more PRACH resources classified depending on a coverage class from an eNB through higher layer signaling.

Furthermore, in the one or more PRACH resources classified depending on the coverage class of a UE, the number of subframes in which a random access signal is transmitted may be differently set.

Furthermore, a guard band may be present between the first PRACH resource region and the second PRACH resource region.

Thereafter, the UE may receive control information related to a PRACH resource in which data is transmitted from an eNB prior to/after step S3010 (S3020).

That is, the UE may receive the control information related to the resource of data transmission from the eNB so that it can transmit data in the specific PRACH resource region.

When the UE receives the control information, the UE may transmit the data to the eNB through one of the first PRACH resource region and the second PRACH resource region based on the received control information (S3030).

In this case, the data transmitted through the PRACH resource region may be transmitted through one or more subcarriers having the aforementioned specific subcarrier spacing.

General Apparatus to which the Present Invention May be Applied

FIG. 31 shows an example of an internal block diagram of a wireless communication apparatus to which the methods proposed by this specification may be applied.

Referring to FIG. 31, the wireless communication system includes an eNB 3110 and a plurality of UEs 3120 located within the eNB 3110 region.

The eNB 3110 includes a processor 3111, memory 3112 and a radio frequency (RF) unit 3113. The processor 3111 implements the functions, processes and/or methods proposed in FIGS. 1 to 30. The layers of a radio interface protocol may be implemented by the processor 3111. The memory 3112 is connected to the processor 3111 and stores various types of information for driving the processor 3111. The RF unit 3113 is connected to the processor 3111 and transmits and/or receives a radio signal.

The UE 3120 includes a processor 3121, memory 3122 and an RF unit 3123. The processor 3121 implements the functions, processes and/or methods proposed in FIGS. 1 to 30. The layers of a radio interface protocol may be implemented by the processor 3121. The memory 3122 is connected to the processor 3121 and stores various types of information for driving the processor 3121. The RF unit 3123 is connected to the processor 3121 and transmits and/or receives a radio signal.

The memory 3112, 3122 may be located inside or outside the processor 3111, 3121 and may be connected to the processor 3111, 3121 by various well-known means.

Furthermore, the eNB 3110 and/or the UE 3120 may have a single antenna or multiple antennas.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The method of transmitting a random access signal in a wireless communication system of this specification has been illustrated based on an example in which the method is applied to the 3GPP LTE/LTE-A systems, but may be applied to various wireless communication systems, such as the 5G system, in addition to the 3GPP LTE/LTE-A systems.

1. A method for transmitting a random access signal in a wireless communication system, the method performed by an user equipment (UE) comprising:
transmitting the random access signal to an eNB via a physical random access channel (PRACH) resource region of a narrow band (NB) having a system bandwidth of 180 kHz,
wherein the PRACH resource region comprises a first PRACH resource region and a second PRACH resource region,
each of the first PRACH resource region and the second PRACH resource region comprises at least one subcarrier having a specific subcarrier spacing, and any one of the first PRACH resource region and the second PRACH resource region is adaptively used for data transmission.

2. The method of claim 1, wherein the first PRACH resource region and the second PRACH resource region are divided in a frequency domain.

3. The method of claim 2, further comprising:
receiving control information related to a PRACH resource in which data is transmitted from the eNB; and
transmitting the data to the eNB through any one of the first PRACH resource region and the second PRACH resource region based on the received control information.

4. The method of claim 3, wherein the data is transmitted to the eNB through one or more subcarriers having the specific subcarrier spacing.

5. The method of claim 1, wherein the PRACH resource region comprises one or more PRACH resources divided based on a coverage class of the UE.

6. The method of claim 5, wherein the one or more PRACH resources are configured as PRACH sequences having different lengths and/or different PRACH preamble formats.

7. The method of claim 5, further comprising:
receiving information related to the one or more PRACH resources divided based on the coverage class of the UE through higher layer signaling from the eNB.

8. The method of claim 5, wherein in the one or more PRACH resources divided based on the coverage class of the UE, a number of subframes in which the random access signal is transmitted is differently set.

9. The method of claim 1, wherein a guard band is located between the first PRACH resource region and the second PRACH resource region.

10. An user equipment (UE) for transmitting a random access signal in a wireless communication system, the UE comprising:
a radio frequency (RF) unit for transmitting or receiving a radio signal; and
a processor functionally connected to the RF unit,
wherein the processor is configured to transmit the random access signal to an eNB via a physical random access channel (PRACH) resource region of a narrow band (NB) having a system bandwidth of 180 kHz,
wherein the PRACH resource region comprises a first PRACH resource region and a second PRACH resource region,
each of the first PRACH resource region and the second PRACH resource region comprises at least one subcarrier having a specific subcarrier spacing, and
any one of the first PRACH resource region and the second PRACH resource region is adaptively used for data transmission.

11. The UE of claim 10, wherein the processor is configured to:
receive control information related to a PRACH resource in which data is transmitted from the eNB; and
transmit the data to the eNB through any one of the first PRACH resource region and the second PRACH resource region based on the received control information.

12. The UE of claim 10, wherein the PRACH resource region comprises one or more PRACH resources divided based on a coverage class of the UE.

13. The UE of claim 12, wherein the processor is configured to:
receive information related to the one or more PRACH resources divided based on the coverage class of the UE through higher layer signaling from the eNB.

14. A method for transmitting a random access signal in a wireless communication system, the method performed by an user equipment (UE) comprising:
transmitting the random access signal to an eNB through a narrow band (NB) having a system bandwidth of 200 kHz or less,
wherein the narrow band (NB) comprises 48 subcarriers having a specific subcarrier spacing, and
the random access signal is transmitted using some of the 48 subcarriers.

15. The method of claim 14, wherein a format of the transmitted random transmission signal has a format identical with a physical uplink shared channel (PUSCH) or a form in which a demodulation reference signal (DM-RS) or a preamble is transmitted ahead of the PUSCH.
